(19) United States
(12) Patent Application Publication
(10) Pub. No.: US 2026/0125115 A1
(43) Pub. Date: May 7, 2026

(54) VEHICLE MUDFLAP SYSTEM AND KIT

(71) Applicant: Integrity Auto Group Inc., Westminster, MD (US)

(72) Inventors: Antonio Reno GONZALEZ, Schererville, IN (US); Tyler S. IVY, Hanover, PA (US); Jalil George JABAJI, Timonium, MD (US)

(73) Assignee: Integrity Auto Group Inc., Westminster, MD (US)

(21) Appl. No.: 19/376,937

(22) Filed: Nov. 1, 2025

Related U.S. Application Data
(60) Provisional application No. 63/716,791, filed on Nov. 6, 2024.

(51) Int. Cl. B62D 25/16

(52) U.S. Cl. CPC B62D 25/163

(57) ABSTRACT

A mud flap system for a vehicle includes at least a rear passenger side mud flap with a rear passenger side mud flap upper mounting bracket and a rear passenger side central mounting bracket assembly. The rear passenger side mud flap upper mounting bracket configured to slideably connect a rear passenger side mud flap mounting extension of the rear passenger side mud flap to a vehicle surface, and the rear passenger side central mounting bracket assembly configured to slideably connect a rear passenger side mud flap upper edge to a vehicle second surface. The mud flap system for a vehicle may also include at least a rear driver side mud flap, a front passenger side mud flap, and/or a front drive side mud flap. The rear driver side mud flap may be substantially similar in construction to the rear passenger side mud flap. The front passenger side mud flap may include a front passenger side mounting bracket configured to slideably connect the front passenger side mud flap to a vehicle surface. The front drive side mud flap may be substantially; similar in construction to the front passenger side mud flap.

### CROSS REFERENCES AND PRIORITIES

This Application claims priority from U.S. Provisional Application No. 63/716,791 filed on 6 Nov. 2024, the teachings of which are incorporated by reference herein in their entirety.

### BACKGROUND

Many vehicles have tires which are partially or fully recessed in wheel wells with a portion of the tire extending below the fenders and other body components of the vehicle. As the tire rotates during vehicle operation, the tire has a tendency to disperse water, mud, dirt, stones and other debris from the road surface onto the vehicle body panels rearward of the vehicle. In some cases, the water, mud, dirt, stones, or other debris may be dispersed behind the vehicle into traffic.

To mitigate these issues, mud flaps have been designed which attach to the rear of one or more wheel wells of the vehicle and extend downward towards the road surface. During operation, the mud flap blocks much of the water, mud, dirt, stone, or debris which is dispersed by the rotating tire from contacting the vehicle body panels and/or being dispersed behind the vehicle into traffic. Often mud flaps are considered an aftermarket solution which is sold separately from the vehicle and later attached to the wheel wells.

Many solutions for attaching a mud flap to a wheel well of a vehicle have been disclosed. One such solution is disclosed in United States Patent Publication No. 2009/0236814 A1 which describes a mud flap is provided with an integrally molded upstanding tab which captures a free edge of a wheel liner or similar wheel well-forming vehicle body element. The upstanding tab may be combined with OEM screw holes or clamping members to affix the mud flap to the vehicle wheel well.

In practice, existing solutions for attaching a mud flap to a wheel well of a vehicle usually lack adjustability needed to sufficiently block water, mud, dirt, stones, or other debris from being dispersed from the rotating tire onto the vehicle's body panels or into traffic rearward of the vehicle. The existing mud flaps attachment solutions often are only capable of connecting to the vehicle in one position, which may or may not align with the vehicle's tire—in particular when aftermarket tire, wheel, and/or suspension upgrades have been made.

The need exists, therefore, for an improved mud flap system which allows for the mud flap to be adjusted within the vehicle's wheel well to position the mud flap to block more of the water, mud, dirt, stones, or other debris dispersed by the rotating tire from impacting the vehicle's body panels and/or being dispersed behind the vehicle into traffic.

### SUMMARY

Disclosed herein is a mud flap system for a vehicle. The mud flap system includes a rear passenger side mud flap, a rear passenger side mud flap upper mounting bracket, and a rear passenger side central mounting bracket assembly.

The rear passenger side mud flap includes a rear passenger side mud flap interior edge, a rear passenger side mud flap exterior edge, opposite the rear passenger side mud flap interior edge, a rear passenger side mud flap lower end, and a rear passenger side mud flap upper end opposite the rear passenger side mud flap lower end. The rear passenger side mud flap interior edge, rear passenger side mud flap exterior edge, rear passenger side mud flap lower end, and rear passenger side mud flap upper end form a rear passenger side mud flap plane defining a rear passenger side mud flap outer surface and a rear passenger side mud flap inner surface opposite the rear passenger side mud flap outer surface.

The rear passenger side mud flap also includes a plurality of rear passenger side mud flap mounting holes passing from the rear passenger side mud flap outer surface through the rear passenger side mud flap inner surface along the rear passenger side mud flap upper end.

The rear passenger side mud flap further includes a rear passenger side mud flap mounting extension extending from a portion of the rear passenger side mud flap upper end. The rear passenger side mud flap mounting extension includes a rear passenger side extension interior edge, a rear passenger side extension exterior edge opposite the rear passenger side extension interior edge, a rear passenger side extension lower end connected to the rear passenger side mud flap upper end, and a rear passenger side extension upper end opposite the rear passenger side extension lower end. The rear passenger side extension interior edge, rear passenger side exterior edge, rear passenger side extension lower end, and rear passenger side extension upper end forming a rear passenger side extension plane defining a rear passenger side extension outer surface and a rear passenger side extension inner surface opposite the rear passenger side extension outer surface.

The rear passenger side mud flap also includes a rear passenger side mud flap mounting slot passing from the rear passenger side extension outer surface through the rear passenger side extension inner surface along the rear passenger side extension upper end.

The rear passenger side mud flap upper mounting bracket includes at least one rear passenger side bracket vehicle connection hole configured to connect the rear passenger side mud flap upper mounting bracket to a vehicle first surface by a first fastener. The rear passenger side mud flap upper mounting bracket also includes at least one rear passenger side extension connection hole configured to connect the rear passenger side mud flap upper mounting bracket to the rear passenger side mud flap mounting extension by a second fastener passing through the rear passenger side mud flap mounting slot and into the rear passenger side extension connection hole.

The rear passenger side central mounting bracket assembly includes a rear passenger side mud flap attachment and a rear passenger side vehicle attachment mechanism. The rear passenger side mud flap attachment includes a plurality of rear passenger side mud flap connection holes and at least one rear passenger side mud flap attachment slot. The plurality of rear passenger side mud flap connection holes are configured to connect the rear passenger side mud flap attachment to the rear passenger side mud flap by passing a third fastener through a rear passenger side mud flap connection hole of the plurality of rear passenger side mud flap connection holes and into a rear passenger side mud flap central mounting hole of the plurality of rear passenger side mud flap central mounting holes.

The rear passenger side vehicle attachment mechanism includes at least one rear passenger side vehicle connection hole configured to connect the rear passenger side vehicle attachment mechanism to a vehicle second surface by a fourth fastener. The rear passenger side vehicle attachment mechanism also includes at least one first vehicle attachment connection hole configured to connect the rear passenger side vehicle attachment mechanism to the rear passenger side mud flap attachment by a fifth fastener passing through the rear passenger side mud flap attachment slot and into the first vehicle attachment connection hole.

In some embodiments, the rear passenger side mud flap upper mounting bracket may include a rear passenger side upper mounting bracket central plate, a rear passenger side upper mounting bracket lower arm, a rear passenger side upper mounting bracket lower tab, a rear passenger upper side mounting bracket upper arm, and a rear passenger side upper mounting bracket upper tab. The rear passenger side upper mounting bracket central plate may have the at least one rear passenger side extension connection hole passing through therethrough. The rear passenger side upper mounting bracket lower arm may extend forward from a rear passenger side upper mounting bracket central plate first edge at a rear passenger side upper mounting bracket central plate lower end. The rear passenger side upper mounting bracket lower tab may extend inward from a rear passenger side upper mounting bracket lower arm terminal end. A first of the at least one rear passenger side bracket vehicle connection holes may pass through the rear passenger side upper mounting bracket lower tab. The rear passenger side upper mounting bracket upper arm may extend forward from a rear passenger side upper mounting bracket central plate second edge at a rear passenger side upper mounting bracket central plate upper end. The rear passenger side upper mounting bracket upper tab may extend upward from a rear passenger side upper mounting bracket upper arm terminal end. A second of the at least one rear passenger side bracket vehicle connection holes may pass through the rear passenger side upper mounting bracket upper tab.

In certain embodiments, the rear passenger side vehicle attachment mechanism may include a rear passenger side vehicle attachment central plate, a rear passenger side vehicle attachment proximal plate, a rear passenger side vehicle attachment terminal plate, a rear passenger side vehicle attachment arm, and a rear passenger side vehicle attachment tab. The rear passenger side vehicle attachment proximal plate may extend downward from a rear passenger side vehicle attachment central plate proximal edge with the at least one first vehicle attachment connection hole passing through the rear passenger side vehicle attachment proximal plate. The rear passenger side vehicle attachment terminal plate may extend downward from a rear passenger side vehicle attachment central plate terminal edge with at least a first of the at least one rear passenger side vehicle connection holes passing through the rear passenger side vehicle attachment terminal plate. The rear passenger side vehicle attachment arm may extend forward from a rear passenger side vehicle attachment terminal plate first edge at a rear passenger side vehicle attachment terminal plate lower end. The rear passenger side vehicle attachment tab may extend outward from a rear passenger side vehicle attachment arm terminal end with at least a second of the at least one rear passenger side vehicle connection holes passing through the rear passenger side vehicle attachment tab.

In some embodiments, the mud flap system may further include a rear drive side mud flap, a rear driver side mud flap upper mounting bracket, and a rear driver side central mounting bracket assembly.

The rear driver side mud flap includes a rear driver side mud flap interior edge, a rear driver side mud flap exterior edge, opposite the rear driver side mud flap interior edge, a rear driver side mud flap lower end, and a rear driver side mud flap upper end opposite the rear driver side mud flap lower end. The rear driver side mud flap interior edge, rear driver side mud flap exterior edge, rear driver side mud flap lower end, and rear driver side mud flap upper end form a rear driver side mud flap plane defining a rear driver side mud flap outer surface and a rear driver side mud flap inner surface opposite the rear driver side mud flap outer surface.

The rear driver side mud flap also includes a plurality of rear driver side mud flap mounting holes passing from the rear driver side mud flap outer surface through the rear driver side mud flap inner surface along the rear driver side mud flap upper end.

The rear driver side mud flap further includes a rear driver side mud flap mounting extension extending from a portion of the rear driver side mud flap upper end. The rear driver side mud flap mounting extension includes a rear driver side extension interior edge, a rear driver side extension exterior edge opposite the rear driver side extension interior edge, a rear driver side extension lower end connected to the rear driver side mud flap upper end, and a rear driver side extension upper end opposite the rear driver side extension lower end. The rear driver side extension interior edge, rear driver side exterior edge, rear driver side extension lower end, and rear driver side extension upper end forming a rear driver side extension plane defining a rear driver side extension outer surface and a rear driver side extension inner surface opposite the rear driver side extension outer surface.

The rear driver side mud flap also includes a rear driver side mud flap mounting slot passing from the rear driver side extension outer surface through the rear driver side extension inner surface along the rear driver side extension upper end.

The rear driver side mud flap upper mounting bracket includes at least one rear driver side bracket vehicle connection hole configured to connect the rear driver side mud flap upper mounting bracket to a vehicle third surface by a sixth fastener. The rear driver side mud flap upper mounting bracket also includes at least one rear driver side extension connection hole configured to connect the rear driver side mud flap upper mounting bracket to the rear driver side mud flap mounting extension by a seventh fastener passing through the rear driver side mud flap mounting slot and into the rear driver side extension connection hole.

The rear driver side central mounting bracket assembly includes a rear driver side mud flap attachment and a rear driver side vehicle attachment mechanism. The rear driver side mud flap attachment includes a plurality of rear driver side mud flap connection holes and at least one rear driver side mud flap attachment slot. The plurality of rear driver side mud flap connection holes are configured to connect the rear driver side mud flap attachment to the rear driver side mud flap by passing an eighth fastener through a rear driver side mud flap connection hole of the plurality of rear driver side mud flap connection holes and into a rear driver side mud flap central mounting hole of the plurality of rear driver side mud flap central mounting holes.

The rear driver side vehicle attachment mechanism includes at least one rear driver side vehicle connection hole configured to connect the rear driver side vehicle attachment mechanism to a vehicle fourth surface by a ninth fastener. The rear driver side vehicle attachment mechanism also includes at least one rear driver side vehicle attachment connection hole configured to connect the rear driver side vehicle attachment mechanism to the rear driver side mud flap attachment by a tenth fastener passing through the rear driver side mud flap attachment slot and into the rear driver side vehicle attachment connection hole.

In some embodiments, the rear driver side mud flap upper mounting bracket may include a rear driver side upper mounting bracket central plate, a rear driver side upper mounting bracket lower arm, a rear driver side upper mounting bracket lower tab, a rear driver side upper mounting bracket upper arm, and a rear driver side upper mounting bracket upper tab. The rear driver side upper mounting bracket central plate may have the at least one rear driver side extension connection hole passing therethrough. The rear driver side upper mounting bracket lower arm may extend forward from a rear driver side upper mounting bracket central plate first edge at a rear driver side upper mounting bracket central plate lower end. The rear driver side upper mounting bracket lower tab may extend inward from a rear driver side upper mounting bracket lower arm terminal end. A first of the at least one rear driver side bracket vehicle connection holes may pass through the rear driver side upper mounting bracket lower tab. The rear driver side upper mounting bracket upper arm may extend forward from a rear driver side upper mounting bracket central plate second edge at a rear driver side upper mounting bracket central plate upper end. The rear driver side upper mounting bracket upper tab may extend upward from a rear driver side upper mounting bracket upper arm terminal end. A second of the at least one rear driver side bracket vehicle connection holes may pass through the rear driver side upper mounting bracket upper tab.

In certain embodiments, the rear driver side vehicle attachment mechanism may include a rear driver side vehicle attachment central plate, a rear driver side vehicle attachment proximal plate, a rear driver side vehicle attachment terminal plate, a rear driver side vehicle attachment arm, and a rear driver side vehicle attachment tab. The rear driver side vehicle attachment proximal plate may extend downward from a rear driver side vehicle attachment central plate proximal edge with the at least one rear driver side vehicle attachment connection hole passing through the rear driver side vehicle attachment proximal plate. The rear driver side vehicle attachment terminal plate may extend downward from a rear driver side vehicle attachment central plate terminal edge with at least a first of the at least one rear driver side vehicle connection holes passing through the rear driver side vehicle attachment terminal plate. The rear driver side vehicle attachment arm may extend forward from a rear driver side vehicle attachment terminal plate first edge at a rear driver side vehicle attachment terminal plate lower end. The rear driver side vehicle attachment tab may extend outward from a rear driver side vehicle attachment arm terminal end with at least a second of the at least one rear driver side vehicle connection holes passing through the rear driver side vehicle attachment tab.

In some embodiments, the mud flap system may further include a front passenger side mud flap and a front passenger side mounting bracket. The front passenger side mud flap may include a front passenger side mud flap interior edge, a front passenger side mud flap exterior edge opposite the front passenger side mud flap interior edge, a front passenger side mud flap lower end, and a front passenger side mud flap upper end opposite the front passenger side mud flap lower end. The front passenger side mud flap interior edge, front passenger side mud flap exterior edge, front passenger side mud flap lower end, and front passenger side mud flap upper end form a front passenger side mud flap plane defining a front passenger side mud flap outer surface and a front passenger side mud flap inner surface opposite the front passenger side mud flap outer surface. A front passenger side mud flap recess extends from the front passenger side mud flap interior edge towards the front passenger side mud flap exterior edge between the front passenger side mud flap lower end and the front passenger side mud flap upper end.

The front passenger side mud flap also includes a front passenger side mud flap mounting extension extending from a portion of the front passenger side mud flap upper end. The front passenger side mud flap mounting extension having a front passenger side extension interior edge, a front passenger side extension exterior edge opposite the front passenger side extension interior edge, a front passenger side extension lower end connected to the front passenger side mud flap upper end, and a front passenger side extension upper end opposite the front passenger side extension lower end. The front passenger side extension interior edge, front passenger side extension exterior edge, front passenger side lower end, and front passenger side upper end form a front passenger side extension plane defining a front passenger side extension outer surface and a front passenger side extension inner surface opposite the front passenger side extension outer surface.

The front passenger side mud flap further includes a plurality of front passenger side mud flap mounting slots including at least a front passenger side mud flap upper mounting slot, a front passenger side mud flap lower mounting slot, and a front passenger side mud flap central mounting slot. The front passenger side mud flap upper mounting slot passing from the front passenger side extension outer surface through the front passenger side extension inner surface. The front passenger side mud flap lower mounting slot passing from the front passenger side mud flap outer surface through the front passenger side mud flap inner surface. The front passenger side mud flap central mounting slot passing from the front passenger side extension outer surface through the front passenger side extension inner surface between the front passenger side mud flap upper mounting slot and the front passenger side mud flap lower mounting slot.

The front passenger side mounting bracket includes at least one front passenger side bracket vehicle connection hole configured to connect the front passenger side mounting bracket to a vehicle fifth surface by an eleventh fastener. The front passenger side mounting bracket also includes at least one front passenger side extension connection hole configured to connect the front passenger side mounting bracket to the front passenger side mud flap mounting extension by a twelfth fastener passing through the front passenger side mud flap upper mounting slot or the front passenger side mud flap central mounting slot and into the front passenger side extension connection hole.

In some embodiments, the front passenger side mounting bracket may include a front passenger side mounting bracket main plate, a front passenger side mounting bracket lip, and a front passenger side mounting bracket tap. The front passenger side mounting bracket main plate having at least one of the front passenger side extension connection holes passing therethrough. The front passenger side mounting bracket lip extending outward from the front passenger side mounting bracket main plate first edge. The front passenger side mounting bracket tab extending inward from a front passenger side mounting bracket lip first edge with at least one of the front passenger side bracket vehicle connection holes passing therethrough.

In some embodiments, the mud flap system may further include a front driver side mud flap and a front driver side mounting bracket. The front driver side mud flap may include a front driver side mud flap interior edge, a front driver side mud flap exterior edge opposite the front driver side mud flap interior edge, a front driver side mud flap lower end, and a front driver side mud flap upper end opposite the front driver side mud flap lower end. The front driver side mud flap interior edge, front driver side mud flap exterior edge, front driver side mud flap lower end, and front driver side mud flap upper end form a front driver side mud flap plane defining a front driver side mud flap outer surface and a front driver side mud flap inner surface opposite the front driver side mud flap outer surface. A front driver side mud flap recess extends from the front driver side mud flap interior edge towards the front driver side mud flap exterior edge between the front driver side mud flap lower end and the front driver side mud flap upper end.

The front driver side mud flap also includes a front driver side mud flap mounting extension extending from a portion of the front driver side mud flap upper end. The front driver side mud flap mounting extension having a front driver side extension interior edge, a front driver side extension exterior edge opposite the front driver side extension interior edge, a front driver side extension lower end connected to the front driver side mud flap upper end, and a front driver side extension upper end opposite the front driver side extension lower end. The front driver side extension interior edge, front driver side extension exterior edge, front driver side lower end, and front driver side upper end form a front driver side extension plane defining a front driver side extension outer surface and a front driver side extension inner surface opposite the front driver side extension outer surface.

The front driver side mud flap further includes a plurality of front driver side mud flap mounting slots including at least a front driver side mud flap upper mounting slot, a front driver side mud flap lower mounting slot, and a front driver side mud flap central mounting slot. The front driver side mud flap upper mounting slot passing from the front driver side extension outer surface through the front driver side extension inner surface. The front driver side mud flap lower mounting slot passing from the front driver side mud flap outer surface through the front driver side mud flap inner surface. The front driver side mud flap central mounting slot passing from the front driver side extension outer surface through the front driver side extension inner surface between the front driver side mud flap upper mounting slot and the front driver side mud flap lower mounting slot.

The front driver side mounting bracket includes at least one front driver side bracket vehicle connection hole configured to connect the front driver side mounting bracket to a vehicle sixth surface by a thirteenth fastener. The front driver side mounting bracket also includes at least one front driver side extension connection hole configured to connect the front driver side mounting bracket to the front driver side mud flap mounting extension by a fourteenth fastener passing through the front driver side mud flap upper mounting slot or the front driver side mud flap central mounting slot and into the front driver side extension connection hole.

In some embodiments, the front driver side mounting bracket may include a front driver side mounting bracket main plate, a front driver side mounting bracket lip, and a front driver side mounting bracket tap. The front driver side mounting bracket main plate having at least one of the front driver side extension connection holes passing therethrough. The front driver side mounting bracket lip extending outward from the front driver side mounting bracket main plate first edge. The front driver side mounting bracket tab extending inward from a front driver side mounting bracket lip first edge with at least one of the front driver side bracket vehicle connection holes passing therethrough.

Further disclosed herein is a mud flap kit which includes any of a rear passenger side mud flap with a rear passenger side mud flap upper mounting bracket, a rear passenger side central mounting bracket assembly; a rear driver side mud flap with a rear driver side mud flap mounting bracket, and a rear driver side central mounting bracket assembly; a front passenger side mud flap with a front passenger side mounting bracket; and a front drive side mud flap with a front drive side mounting bracket.

### BRIEF DESCRIPTION OF FIGURES

FIG. 1 is an isometric view of an exemplary embodiment of a mud flap system for a vehicle.

FIG. 2 is an assembled isometric view of an exemplary embodiment of a first or rear driver side mud flap.

FIG. 3 is an exploded isometric view of the exemplary embodiment of a first or rear driver side mud flap from FIG. 2.

FIG. 4 is an exploded side view of an exemplary embodiment of a first or rear driver side mud flap.

FIG. 5 is an assembled side view of the exemplary embodiment of a first or rear driver side mud flap from FIG. 4.

FIG. 6 is an assembled isometric view of an exemplary embodiment of a third or front drive side mud flap.

FIG. 7 is an exploded isometric view of the exemplary embodiment of a third or front drive side mud flap from FIG. 6.

FIG. 8 is an exploded side view of an exemplary embodiment of a third or fourth flap.

FIG. 9 is an assembled side view of the exemplary embodiment of a third or fourth flap from FIG. 8.

FIG. 10 is an exploded isometric view of an exemplary embodiment of a mud flap system with a vehicle.

FIG. 11 is an exploded isometric view of an exemplary embodiment of a first or rear driver side mud flap with a vehicle.

FIG. 12 is an assembled isometric view of the exemplary embodiment of a first or rear driver side mud flap with a vehicle from FIG. 11.

FIG. 13 is a close up view of a first portion of a bracket assembly of a first or rear driver side mud flap to a vehicle.

FIG. 14 is a close up view of a second portion of a bracket assembly of a first or rear driver side mud flap to a vehicle.

FIG. 15 is an exploded isometric view of an exemplary embodiment of a third or front drive side mud flap with a vehicle.

FIG. 16 is an assembled isometric view of the exemplary embodiment of a third or front drive side mud flap with a vehicle from FIG. 15.

FIG. 17 is a close up view of a bracket assembly of a third or front drive side mud flap to a vehicle.

### DETAILED DESCRIPTION

Disclosed herein is a mud flap system for a vehicle. The mud flap system is described below with reference to the Figures. As described herein, the following numbers refer to the following structures as noted in the Figures.
10 refers to a mud flap system.
50 refers to a vehicle.
51 refers to a vehicle first surface.
52 refers to a vehicle second surface.
53 refers to a vehicle third surface.
54 refers to a vehicle fourth surface.
55 refers to a vehicle fifth surface.
56 refers to a vehicle sixth surface.
100 refers to a rear passenger side mud flap.
110 refers to a rear passenger side mud flap interior edge.
120 refers to a rear passenger side mud flap exterior edge.
130 refers to a rear passenger side mud flap lower end.
140 refers to a rear passenger side mud flap upper end.
150 refers to a rear passenger side mud flap outer surface.
160 refers to a rear passenger side mud flap inner surface.
170 refers to a rear passenger side mud flap central mounting hole.
180 refers to a rear passenger side mud flap mounting extension.
181 refers to a rear passenger side extension interior edge.
182 refers to a rear passenger side extension exterior edge.
183 refers to a rear passenger side extension lower end.
184 refers to a rear passenger side extension upper end.
185 refers to a rear passenger side extension outer surface.
186 refers to a rear passenger side extension inner surface.
190 refers to a rear passenger side mud flap mounting slot.
200 refers to a rear passenger side mud flap upper mounting bracket.
210 refers to a rear passenger side bracket vehicle connection hole.
220 refers to a first fastener.
230 refers to a rear passenger side extension connection hole.
240 refers to a second fastener.
250 refers to a rear passenger side upper mounting bracket central plate.
251 refers to a rear passenger side upper mounting bracket central plate first edge.
252 refers to a rear passenger side upper mounting bracket central plate lower end.
253 refers to a rear passenger side upper mounting bracket central plate second edge.
254 refers to a rear passenger side upper mounting bracket central plate upper end.
260 refers to a rear passenger side upper mounting bracket lower arm.
261 refers to a rear passenger side upper mounting bracket lower arm terminal end.
270 refers to a rear passenger side upper mounting bracket lower tab.
280 refers to a rear passenger side upper mounting bracket upper arm.
281 refers to a rear passenger side upper mounting bracket upper arm terminal end.
290 refers to a rear passenger side upper mounting bracket upper tab.
300 refers to a rear passenger side central mounting bracket assembly.
310 refers to a rear passenger side mud flap attachment.
311 refers to a rear passenger side mud flap connection hole.
312 refers to a third fastener.
313 refers to a rear passenger side mud flap attachment slot.
320 refers to a rear passenger side vehicle attachment mechanism.
321 refers to a rear passenger side vehicle connection hole.
322 refers to a fourth fastener.
323 refers to a first vehicle attachment connection hole.
324 refers to a fifth fastener.
325 refers to a rear passenger side vehicle attachment central plate.
326 refers to a rear passenger side vehicle attachment proximal plate.
327 refers to a rear passenger side vehicle attachment terminal plate.
328 refers to a rear passenger side vehicle attachment arm.
329 refers to a rear passenger side vehicle attachment tab.
400 refers to a rear driver side mud flap.
410 refers to a rear driver side mud flap interior edge.
420 refers to a rear driver side mud flap exterior edge.
430 refers to a rear driver side mud flap lower end.
440 refers to a rear driver side mud flap upper end.
450 refers to a rear driver side mud flap outer surface.
460 refers to a rear driver side mud flap inner surface.
470 refers to a rear driver side mud flap central mounting hole.
480 refers to a rear driver side mud flap mounting extension.
481 refers to a rear driver side extension interior edge.
482 refers to a rear driver side extension exterior edge.
483 refers to a rear driver side extension lower end.
484 refers to a rear driver side extension upper end.
485 refers to a rear driver side extension outer surface.
486 refers to a rear driver side extension inner surface.
490 refers to a rear driver side mud flap mounting slot.
500 refers to a rear driver side mud flap upper mounting bracket.
510 refers to a rear driver side bracket vehicle connection hole.
520 refers to a sixth fastener.
530 refers to a rear driver side extension connection hole.
540 refers to a seventh fastener.
550 refers to a rear driver side upper mounting bracket central plate.
551 refers to a rear driver side upper mounting bracket central plate first edge.
552 refers to a rear driver side upper mounting bracket central plate lower end.
553 refers to a rear driver side upper mounting bracket central plate second edge.
554 refers to a rear driver side upper mounting bracket central plate upper end.
560 refers to a rear driver side upper mounting bracket lower arm.
561 refers to a rear driver side upper mounting bracket lower arm terminal end.
570 refers to a rear driver side upper mounting bracket lower tab.
580 refers to a rear driver side upper mounting bracket upper arm.
581 refers to a rear driver side upper mounting bracket upper arm terminal end.
590 refers to a rear driver side upper mounting bracket upper tab.
600 refers to a rear driver side central mounting bracket assembly.
610 refers to a rear driver side mud flap attachment.
611 refers to a rear driver side mud flap connection hole.
612 refers to an eighth fastener.
613 refers to a rear driver side mud flap attachment slot.
620 refers to a rear driver side attachment mechanism.
621 refers to a rear driver side connection hole.
622 refers to a ninth fastener.
623 refers to a rear driver side vehicle attachment connection hole.
624 refers to a tenth fastener.
625 refers to a rear driver side vehicle attachment central plate.
626 refers to a rear driver side vehicle attachment proximal plate.
627 refers to a rear driver side vehicle attachment terminal plate.
628 refers to a rear driver side vehicle attachment arm.
629 refers to a rear driver side vehicle attachment tab.
700 refers to a front passenger side mud flap.
710 refers to a front passenger side mud flap interior edge.
720 refers to a front passenger side mud flap exterior edge.
725 refers to a front passenger side mud flap recess.
730 refers to a front passenger side mud flap lower end.
740 refers to a front passenger side mud flap upper end.
750 refers to a front passenger side mud flap outer surface.
760 refers to a front passenger side mud flap inner surface.
770 refers to a front passenger side mud flap mounting extension.
771 refers to a front passenger side extension interior edge.
772 refers to a front passenger side extension exterior edge.
773 refers to a front passenger side extension lower end.
774 refers to a front passenger side extension upper end.
775 refers to a front passenger side extension outer surface.
776 refers to a front passenger side extension inner surface.
780 refers to a front passenger side mud flap mounting slot.
781 refers to a front passenger side mud flap upper mounting slot.
782 refers to a front passenger side mud flap lower mounting slot.
783 refers to a front passenger side mud flap central mounting slot.
800 refers to a front passenger side mounting bracket.
810 refers to a front passenger side bracket vehicle connection hole.
820 refers to an eleventh fastener.
830 refers to a front passenger side extension connection hole.
840 refers to a twelfth fastener.
850 refers to a front passenger side mounting bracket main plate.
851 refers to a front passenger side mounting bracket main plate first edge.
860 refers to a front passenger side mounting bracket lip.
861 refers to a front passenger side mounting bracket lip first edge.
870 refers to a front passenger side mounting bracket tab.
900 refers to a front drive side mud flap.
910 refers to a front drive side mud flap interior edge.
920 refers to a front drive side mud flap exterior edge.
925 refers to a front drive side mud flap recess.
930 refers to a front drive side mud flap lower end.
940 refers to a front drive side mud flap upper end.
950 refers to a front drive side mud flap outer surface.
960 refers to a front drive side mud flap inner surface.
970 refers to a front drive side mud flap mounting extension.
971 refers to a front drive side extension interior edge.
972 refers to a front drive side extension exterior edge.
973 refers to a front drive side extension lower end.
974 refers to a front drive side extension upper end.
975 refers to a front drive side extension outer surface.
976 refers to a front drive side extension inner surface.
980 refers to a front drive side mud flap mounting slot.
981 refers to a front drive side mud flap upper mounting slot.
982 refers to a front drive side mud flap lower mounting slot.
983 refers to a front drive side mud flap central mounting slot.
1000 refers to a front drive side mounting bracket.
1010 refers to a front drive side bracket vehicle connection hole.
1020 refers to a thirteenth fastener.
1030 refers to a front drive side extension connection hole.
1040 refers to a fourteenth fastener.
1050 refers to a front drive side mounting bracket main plate.
1051 refers to a front drive side mounting bracket main plate first edge.
1060 refers to a front drive side mounting bracket lip.
1061 refers to a front drive side mounting bracket lip first edge.
1070 refers to a front drive side mounting bracket tab.

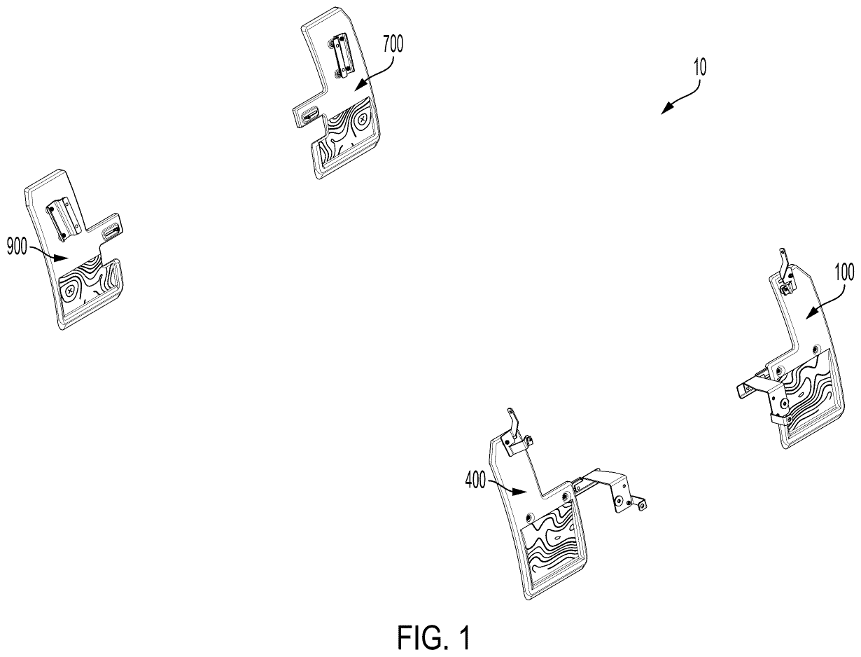

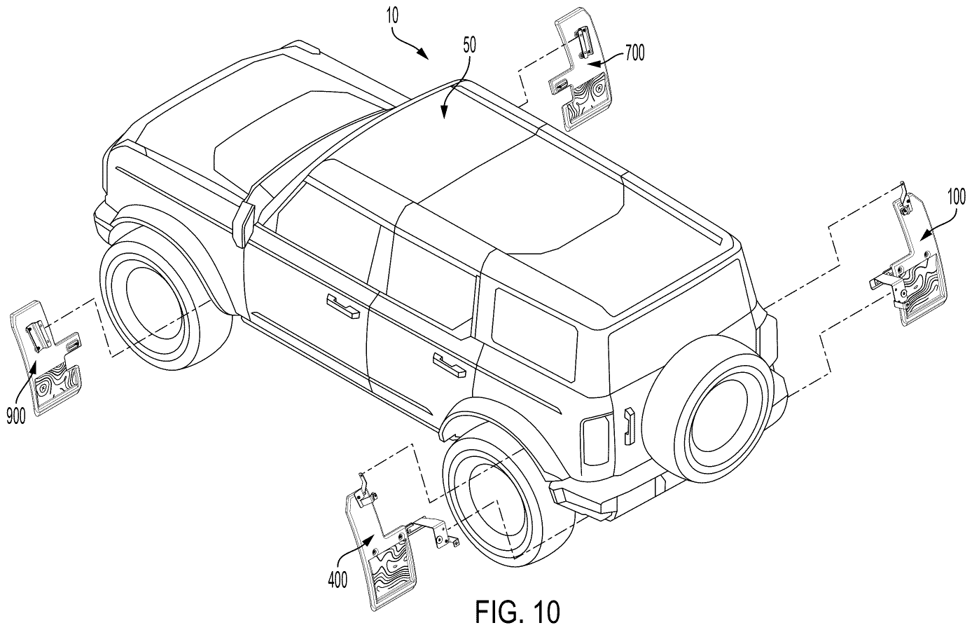

FIG. 1 illustrates an isometric view of a mud flap system (10) for a vehicle ((50) as shown in FIG. 10). As shown in FIG. 1, the mud flap system may include a rear passenger side mud flap (100), a rear driver side mud flap (400), a front passenger side mud flap (700), and a front drive side mud flap (900). The rear passenger side mud flap being configured to connect to the rear passenger side wheel well of the vehicle—also known as the right rear wheel well of the vehicle—in a left-hand drive vehicle commonly found in the United States. The rear driver side mud flap being configured to connect to the rear driver side wheel well of the vehicle—also known as the left rear wheel well of the vehicle—in a left-hand drive vehicle. The front passenger side mud flap being configured to connect to the front passenger side wheel well of the vehicle—also known as the right front wheel well of the vehicle—in a left-hand drive vehicle. The front drive side mud flap being configured to connect to the front driver side wheel well of the vehicle—also known as the left front wheel well of the vehicle—in a left-hand drive vehicle.

While FIG. 1 illustrates the mud flap system (10) having four mud flaps, other embodiments may exist. For example, in some embodiments, the mud flap system may include only two mud flaps—which preferably will be either the rear passenger side mud flap (100) and the rear driver side mud flap (400) (which may be referred to as a rear mud flap system) or the front passenger side mud flap (700) and the front drive side mud flap (900) (which may be referred to as a front mud flap system). Other embodiments may include only a single mud flap—which may be the rear passenger side mud flap, the rear driver side mud flap, the front passenger side mud flap, or the front drive side mud flap—and mounting hardware for connecting said mud flap to the corresponding location on the vehicle ((50) as shown in FIG. 10).

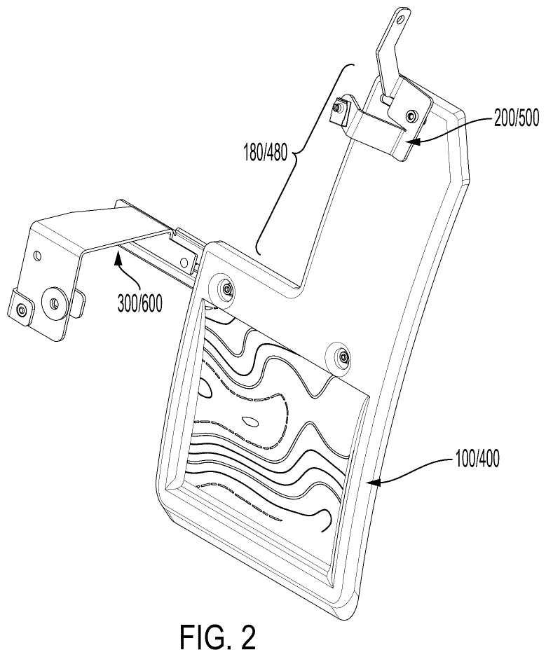

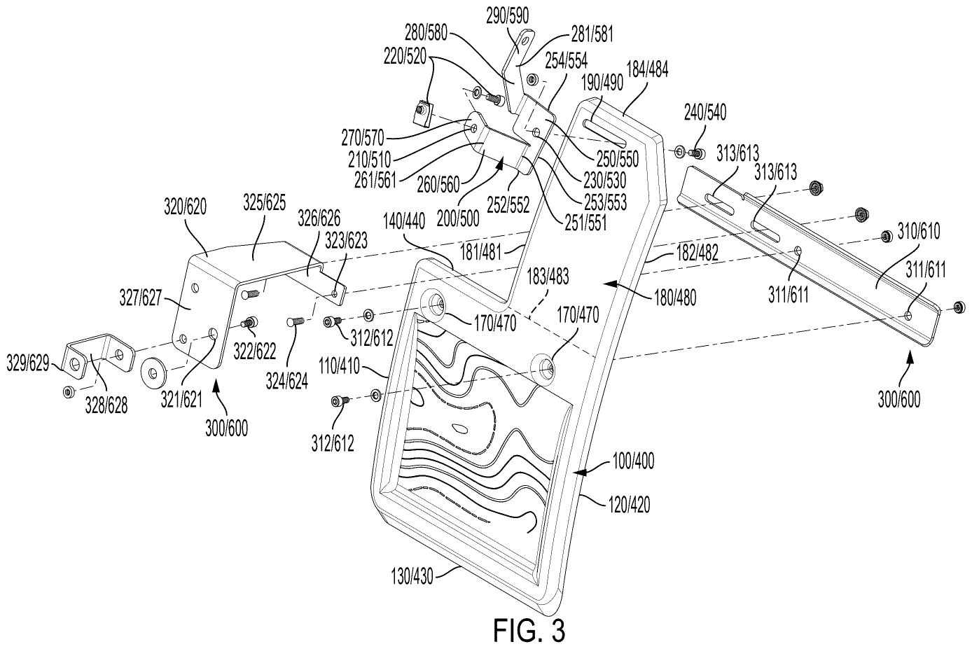

FIG. 2 illustrates an isometric view of the rear passenger side mud flap (100) in assembled form with FIG. 3 illustrating various components of the rear passenger side mud flap separated from one another. While FIGS. 2 and 3 illustrate the rear passenger side mud flap, one will recognize that the rear driver side mud flap (400) is substantially similar to the rear passenger side mud flap and includes the same components in a reversed or mirrored configuration. Accordingly, FIGS. 2 and 3 are labelled with numbers corresponding to either the rear passenger side mud flap or the rear driver side mud flap.

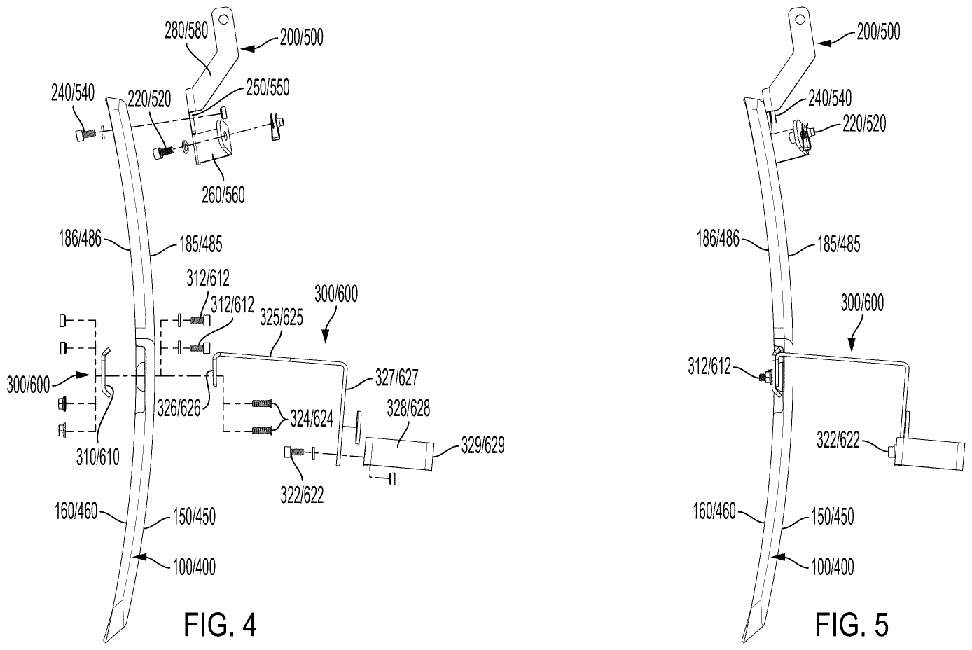

As shown in FIGS. 2 and 3, the rear passenger side mud flap (100) has a rear passenger side mud flap interior edge (110) and a rear passenger side mud flap exterior edge (120) opposite the rear passenger side mud flap interior edge. Extending between the rear passenger side mud flap interior edge and the rear passenger side mud flap exterior edge at a bottom end thereof is a rear passenger side mud flap lower end (130) while a rear passenger side mud flap upper end (140) is opposite the rear passenger side mud flap lower end. The rear passenger side mud flap interior edge, rear passenger side mud flap exterior edge, rear passenger side mud flap lower end, and rear passenger side mud flap upper end form a rear passenger side mud flap plane defining a rear passenger side mud flap outer surface ((150) as shown in FIG. 4) and a rear passenger side mud flap inner surface ((160) as shown in FIG. 4). A plurality of rear passenger side mud flap central mounting holes (170) pass from the rear passenger side mud flap outer surface through the rear passenger side mud flap inner surface along the rear passenger side mud flap upper end.

Extending from a portion of the rear passenger side mud flap upper end (140) is a rear passenger side mud flap mounting extension (180). The rear passenger side mud flap mounting extension having a rear passenger side extension interior edge (181) and a rear passenger side extension exterior edge (182) opposite the rear passenger side extension interior edge. Extending between the rear passenger side extension interior edge and the rear passenger side extension exterior edge at a bottom end thereof is a rear passenger side extension lower end (183) while a rear passenger side extension upper end (184) is opposite the rear passenger side extension lower end. The rear passenger side extension interior edge, rear passenger side extension exterior edge, rear passenger side extension lower end, and rear passenger side extension upper end form a rear passenger side extension plane defining a rear passenger side extension outer surface ((185) as shown in FIG. 4) and a rear passenger side extension inner surface ((186) as shown in FIG. 4). A rear passenger side mud flap mounting slot (190) passes from the rear passenger side extension outer surface through the rear passenger side extension inner surface along the rear passenger side extension upper end.

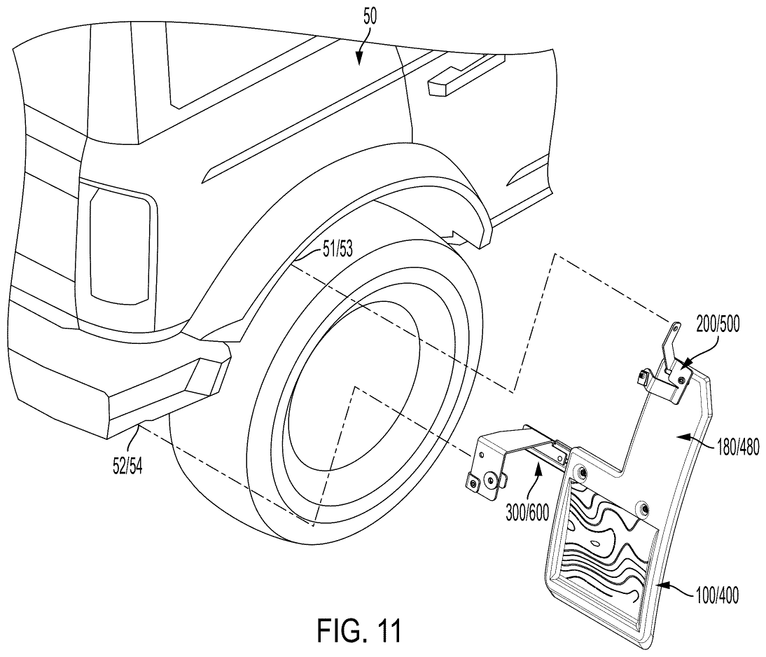

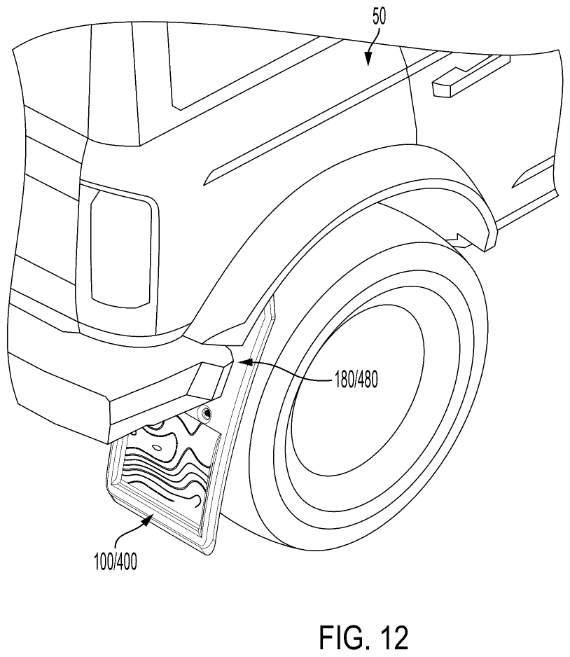

When the mud flap system (10) includes the rear passenger side mud flap (100), the device will also include a rear passenger side mud flap upper mounting bracket (200) as shown in FIGS. 2 and 3. The rear passenger side mud flap upper mounting bracket including at least one rear passenger side bracket vehicle connection hole (210) which is configured to connect the rear passenger side mud flap upper mounting bracket to a vehicle first surface ((51) as shown in FIG. 11) by a first fastener (220). The rear passenger side mud flap upper mounting bracket also including at least one rear passenger side extension connection hole (230) configured to connect the rear passenger side mud flap upper mounting bracket to the rear passenger side mud flap mounting extension (180) by a second fastener (240) passing through the rear passenger side mud flap mounting slot (190) and into the rear passenger side extension connection hole.

As shown in FIGS. 2 and 3, an exemplary embodiment of the rear passenger side mud flap upper mounting bracket (200) may include a rear passenger side upper mounting bracket central plate (250), a rear passenger side upper mounting bracket lower arm (260), a rear passenger side upper mounting bracket lower tab (270), a rear passenger side upper mounting bracket upper arm (280), and a rear passenger side upper mounting bracket upper tab (290). The rear passenger side upper mounting bracket central plate having the at least one rear passenger side extension connection hole (230) passing therethrough. The rear passenger side upper mounting bracket lower arm extending forward from a rear passenger side upper mounting bracket central plate first edge (251) at a rear passenger side upper mounting bracket central plate lower end (252). The rear passenger side upper mounting bracket lower tab extending inward from a rear passenger side upper mounting bracket lower arm terminal end (261) with a first of the at least one rear passenger side bracket vehicle connection holes (210) passing through the rear passenger side upper mounting bracket lower tab. The rear passenger side upper mounting bracket upper arm extending forward from a rear passenger side upper mounting bracket central plate second edge (253) at a rear passenger side upper mounting bracket central plate upper end (254). The rear passenger side upper mounting bracket upper tab extending upward from a rear passenger side upper mounting bracket upper arm terminal end (281) with a second of the at least one rear passenger side bracket vehicle connection holes passing through the rear passenger side upper mounting bracket upper tab.

When discussing directions in the context of the various components of the mounting brackets disclosed herein, forward refers to the direction of the front bumper of a vehicle to which the mud flap is connected. Rearward refers to the direction of the rear bumper of the vehicle to which the mud flap is connected. Inward refers to the direction of the vehicle's central axis—said central axis extending from a mid-point of the vehicle's front bumper to a mid-point of the vehicle's rear bumper. Outward refers to the direction opposite the vehicle's central axis. Upward refers to the direction of the vehicle's roof. Downward refers to the direction opposite the vehicle's roof.

When the mud flap system (10) includes the rear passenger side mud flap (100), the device will also include a rear passenger side central mounting bracket assembly (300) as shown in FIGS. 2 and 3. The rear passenger side central mounting bracket assembly including a rear passenger side mud flap attachment (310) and a rear passenger side vehicle attachment mechanism (320). The rear passenger side mud flap attachment including a plurality of rear passenger side mud flap connection holes (311) and at least one rear passenger side mud flap attachment slot (313). Each rear passenger side mud flap connection hole being configured to connect the rear passenger side mud flap attachment to the rear passenger side mud flap (100) by passing a third fastener (312) through a rear passenger side mud flap connection hole of the plurality of rear passenger side mud flap connection holes and into a rear passenger side mud flap central mounting hole (170) of the plurality of rear passenger side mud flap central mounting holes. The rear passenger side vehicle attachment mechanism including at least one rear passenger side vehicle connection hole (321) configured to connect the rear passenger side vehicle attachment mechanism to a vehicle second surface ((52) as shown in FIG. 11) by a fourth fastener (322). The rear passenger side vehicle attachment mechanism further including at least one first vehicle attachment connection hole (323) configured to connect the rear passenger side vehicle attachment mechanism to the rear passenger side mud flap attachment by a fifth fastener (324) passing through the rear passenger side mud flap attachment slot and into the first vehicle attachment connection hole.

As shown in FIGS. 2 and 3, an exemplary embodiment of the rear passenger side vehicle attachment mechanism (320) may include a rear passenger side vehicle attachment central plate (325), a rear passenger side vehicle attachment proximal plate (326), a rear passenger side vehicle attachment terminal plate (327), a rear passenger side vehicle attachment arm (328), and a rear passenger side vehicle attachment tab (329). The rear passenger side vehicle attachment proximal plate extending downward from a rear passenger side vehicle attachment central plate proximal edge with the at least one first vehicle attachment connection hole (323) passing through the rear passenger side vehicle attachment proximal plate. The rear passenger side vehicle attachment terminal plate extending downward from a rear passenger side vehicle attachment central plate terminal edge with at least a first of the at least one rear passenger side vehicle connection holes (321) passing through the rear passenger side vehicle attachment terminal plate. The rear passenger side vehicle attachment arm extending forward from a rear passenger side vehicle attachment terminal plate first edge at a first vehicle attachment plate lower end. The rear passenger side vehicle attachment tab extending outward from a rear passenger side vehicle attachment arm terminal end with at least a second of the at least one rear passenger side vehicle connection holes passing through the rear passenger side vehicle attachment tab. The rear passenger side vehicle attachment arm may be either removably attached or integrally attached to the rear passenger side vehicle attachment terminal plate. When the rear passenger side vehicle attachment arm is integrally attached to the rear passenger side vehicle attachment terminal plate, they may form a monolithic piece.

As previously noted, the rear driver side mud flap (400) may be substantially similar to the rear passenger side mud flap (100) and may include the same components in a reversed or mirrored configuration. Accordingly, as shown in FIGS. 2 and 3, the rear driver side mud flap has a rear driver side mud flap interior edge (410) and a rear driver side mud flap exterior edge (420) opposite the rear driver side mud flap interior edge. Extending between the rear driver side mud flap interior edge and the rear driver side mud flap exterior edge at a bottom end thereof is a rear driver side mud flap lower end (430) while a rear driver side mud flap upper end (440) is opposite the rear driver side mud flap lower end. The rear driver side mud flap interior edge, rear driver side mud flap exterior edge, rear driver side mud flap lower end, and rear driver side mud flap upper end form a rear driver side mud flap plane defining a rear driver side mud flap outer surface ((450) as shown in FIG. 4) and a rear driver side mud flap inner surface ((460) as shown in FIG. 4). A plurality of rear driver side mud flap central mounting holes (470) pass from the rear driver side mud flap outer surface through the rear driver side mud flap inner surface along the rear driver side mud flap upper end.

Extending from a portion of the rear driver side mud flap upper end (440) is a rear driver side mud flap mounting extension (480). The rear driver side mud flap mounting extension having a rear driver side extension interior edge (481) and a rear driver side extension exterior edge (482) opposite the rear driver side extension interior edge. Extending between the rear driver side extension interior edge and the rear driver side extension exterior edge at a bottom end thereof is a rear driver side extension lower end (483) while a rear driver side extension upper end (484) is opposite the rear driver side extension lower end. The rear driver side extension interior edge, rear driver side extension exterior edge, rear driver side extension lower end, and rear driver side extension upper end form a rear driver side extension plane defining a rear driver side extension outer surface ((485) as shown in FIG. 4) and a rear driver side extension inner surface ((486) as shown in FIG. 4). A rear driver side mud flap mounting slot (490) passes from the rear driver side extension outer surface through the rear driver side extension inner surface along the rear driver side extension upper end.

When the mud flap system (10) includes the rear driver side mud flap (400), the device will also include a rear driver side mud flap upper mounting bracket (500) as shown in FIGS. 2 and 3. The rear driver side mud flap upper mounting bracket including at least one rear driver side bracket vehicle connection hole (510) which is configured to connect the rear driver side mud flap upper mounting bracket to a vehicle third surface ((53) as shown in FIG. 11) by a sixth fastener (520). The rear driver side mud flap upper mounting bracket also including at least one rear driver side extension connection hole (530) configured to connect the rear driver side mud flap upper mounting bracket to the rear driver side mud flap mounting extension (480) by a seventh fastener (540) passing through the rear driver side mud flap mounting slot (490) and into the rear driver side extension connection hole.

As shown in FIGS. 2 and 3, an exemplary embodiment of the rear driver side mud flap upper mounting bracket (500) may include a rear driver side upper mounting bracket central plate (550), a rear driver side upper mounting bracket lower arm (560), a rear driver side upper mounting bracket lower tab (570), a rear driver side upper mounting bracket upper arm (580), and a rear driver side upper mounting bracket upper tab (590). The rear driver side upper mounting bracket central plate having the at least one rear driver side extension connection hole (530) passing therethrough. The rear driver side upper mounting bracket lower arm extending forward from a rear driver side upper mounting bracket central plate first edge (551) at a rear driver side upper mounting bracket central plate lower end (552). The rear driver side upper mounting bracket lower tab extending inward from a rear driver side upper mounting bracket lower arm terminal end (561) with a first of the at least one rear driver side bracket vehicle connection holes (510) passing through the rear driver side upper mounting bracket lower tab. The rear driver side upper mounting bracket upper arm extending forward from a rear driver side upper mounting bracket central plate second edge (553) at a rear driver side upper mounting bracket central plate upper end (554). The rear driver side upper mounting bracket upper tab extending upward from a rear driver side upper mounting bracket upper arm terminal end (581) with a second of the at least one rear driver side bracket vehicle connection holes passing through the rear driver side upper mounting bracket upper tab.

When the mud flap system (10) includes the rear driver side mud flap (400), the device will also include a rear driver side central mounting bracket assembly (600) as shown in FIGS. 2 and 3. The rear driver side central mounting bracket assembly including a rear driver side mud flap attachment (610) and a rear driver side attachment mechanism (620). The rear driver side mud flap attachment including a plurality of rear driver side mud flap connection holes (611) and at least one rear driver side mud flap attachment slot (613). Each rear driver side mud flap connection hole being configured to connect the rear driver side mud flap attachment to the rear driver side mud flap (400) by passing an eighth fastener (612) through a rear driver side mud flap connection hole of the plurality of rear driver side mud flap connection holes and into a rear driver side mud flap central mounting hole (470) of the plurality of rear driver side mud flap central mounting holes. The rear driver side attachment mechanism including at least one rear driver side connection hole (621) configured to connect the rear driver side attachment mechanism to a vehicle fourth surface ((54) as shown in FIG. 11) by a ninth fastener (622). The rear driver side attachment mechanism further including at least one rear driver side vehicle attachment connection hole (623) configured to connect the rear driver side attachment mechanism to the rear driver side mud flap attachment by a tenth fastener (624) passing through the rear driver side mud flap attachment slot and into the rear driver side vehicle attachment connection hole.

As shown in FIGS. 2 and 3, an exemplary embodiment of the rear driver side attachment mechanism (620) may include a rear driver side vehicle attachment central plate (625), a rear driver side vehicle attachment proximal plate (626), a rear driver side vehicle attachment terminal plate (627), a rear driver side vehicle attachment arm (628), and a rear driver side vehicle attachment tab (629). The rear driver side vehicle attachment proximal plate extending downward from a rear driver side vehicle attachment central plate proximal edge with the at least one rear driver side vehicle attachment connection hole (623) passing through the rear driver side vehicle attachment proximal plate. The rear driver side vehicle attachment terminal plate extending downward from a rear driver side vehicle attachment central plate terminal edge with at least a first of the at least one rear driver side connection holes (621) passing through the rear driver side vehicle attachment terminal plate. The rear driver side vehicle attachment arm extending forward from a rear driver side vehicle attachment terminal plate first edge at a second vehicle attachment plate lower end. The rear driver side vehicle attachment tab extending outward from a rear driver side vehicle attachment arm terminal end with at least a second of the at least one rear driver side connection holes passing through the rear driver side vehicle attachment tab. The rear driver side vehicle attachment arm may be either removably attached or integrally attached to the rear driver side vehicle attachment terminal plate. When the rear driver side vehicle attachment arm is integrally attached to the rear driver side vehicle attachment terminal plate, they may form a monolithic piece.

FIGS. 4 and 5 illustrate the rear passenger side mud flap (100) or the rear driver side mud flap (400) respectively from a side view with FIG. 4 showing an exploded view and FIG. 5 showing an assembled view. As shown in FIGS. 4 and 5, the rear passenger side mud flap upper mounting bracket (200) may be connected to the rear passenger side extension outer surface (185) by the second fastener (240) passing through the rear passenger side mud flap mounting slot ((190) as shown in FIG. 3) and into the rear passenger side extension connection hole ((230) as shown in FIG. 3). While FIGS. 4 and 5 illustrate the rear passenger side mud flap upper mounting bracket connected to the rear passenger side extension outer surface, embodiments may exist in which the rear passenger side mud flap upper mounting bracket connects to the rear passenger side extension inner surface (186). As the connection between the rear passenger side mud flap upper mounting bracket and the rear passenger side mud flap involves the second fastener passing through the rear passenger side mud flap mounting slot, the position of the rear passenger side mud flap upper mounting bracket along the width of the rear passenger side mud flap may be adjusted by loosening the second fastener and sliding the rear passenger side mud flap upper mounting bracket along the width of the mud flap before retightening the second fastener. In doing so, in conjunction with adjustments to the connection between the rear passenger side central mounting bracket assembly (300) and the vehicle second surface ((52) as shown in FIG. 11) as described herein, the position of the rear passenger side mud flap within the right rear wheel well may be adjusted to suit an individual's needs and aesthetic preferences.

While the Figures illustrate slots in the rear passenger side mud flap (100) and/or the rear passenger side mud flap mounting extension (180) with holes in the rear passenger side mud flap upper mounting bracket (200) and/or the rear passenger side central mounting bracket assembly (300), other embodiments may exist in which the configuration is reversed. For example, the rear passenger side mud flap mounting slot ((190) as shown in FIG. 3) may be replaced by a rear passenger side mud flap mounting hole while the rear passenger side extension connection hole(s) ((230) as shown in FIG. 3) may be replaced by a rear passenger side extension connection slot.

FIGS. 4 and 5 also illustrate the rear passenger side central mounting bracket assembly (300) connected to the rear passenger side mud flap inner surface (160) by the third fastener (312) passing through a rear passenger side mud flap connection hole ((311) as shown in FIG. 3) of the rear passenger side mud flap connection holes and into a rear passenger side mud flap central mounting hole ((170) as shown in FIG. 3) of the plurality of rear passenger side mud flap central mounting holes. While FIGS. 4 and 5 illustrate the rear passenger side central mounting bracket assembly connected to the rear passenger side mud flap inner surface, embodiments may exist in which the rear passenger side central mounting bracket assembly connects to the rear passenger side mud flap outer surface (150).

As previously noted, the rear driver side mud flap (400) may be substantially similar to the rear passenger side mud flap (100) and may include the same components in a reversed or mirrored configuration. Accordingly, as shown in FIGS. 4 and 5, the rear driver side mud flap upper mounting bracket (500) may be connected to the rear driver side extension outer surface (485) by the seventh fastener (540) passing through the rear driver side mud flap mounting slot ((490) as shown in FIG. 3) and into the rear driver side extension connection hole ((530) as shown in FIG. 3). While FIGS. 4 and 5 illustrate the rear driver side mud flap upper mounting bracket connected to the rear driver side extension outer surface, embodiments may exist in which the rear driver side mud flap upper mounting bracket connects to the rear driver side extension inner surface (486). As the connection between the rear driver side mud flap upper mounting bracket and the rear driver side mud flap involves the seventh fastener passing through the rear driver side mud flap mounting slot, the position of the rear driver side mud flap upper mounting bracket along the width of the rear driver side mud flap may be adjusted by loosening the seventh fastener and sliding the rear driver side mud flap upper mounting bracket along the width of the mud flap before retightening the seventh fastener. In doing so, in conjunction with adjustments to the connection between the rear driver side central mounting bracket assembly (600) and the vehicle fourth surface ((54) as shown in FIG. 11) as described herein, the position of the rear driver side mud flap within the left rear wheel well may be adjusted to suit an individual's needs and aesthetic preferences.

While the Figures illustrate slots in the rear driver side mud flap (400) and/or the rear driver side mud flap mounting extension (480) with holes in the rear driver side mud flap upper mounting bracket (500) and/or the rear driver side central mounting bracket assembly (600), other embodiments may exist in which the configuration is reversed. For example, the rear driver side mud flap mounting slot ((490) as shown in FIG. 3) may be replaced by a rear driver side mud flap mounting hole while the rear driver side extension connection hole(s) ((530) as shown in FIG. 3) may be replaced by a rear driver side extension connection slot.

FIGS. 4 and 5 also illustrate the rear driver side central mounting bracket assembly (600) connected to the rear driver side mud flap inner surface (460) by the eighth fastener (612) passing through a rear driver side mud flap connection hole ((611) as shown in FIG. 3) of the rear driver side mud flap connection holes and into a rear driver side mud flap central mounting hole ((470) as shown in FIG. 3) of the plurality of rear driver side mud flap central mounting holes. While FIGS. 4 and 5 illustrate the rear driver side central mounting bracket assembly connected to the rear driver side mud flap inner surface, embodiments may exist in which the rear driver side central mounting bracket assembly connects to the rear driver side mud flap outer surface (450).

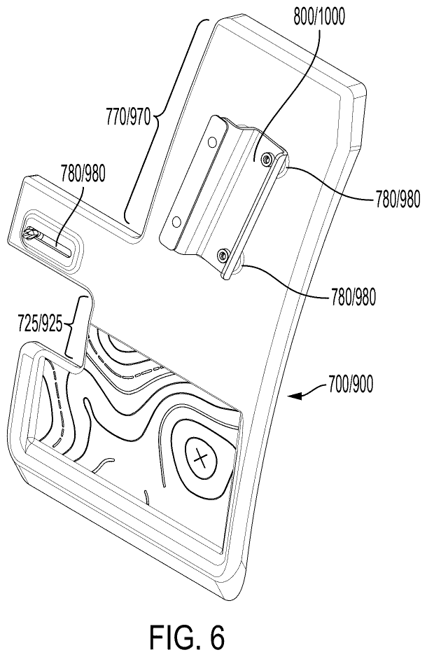

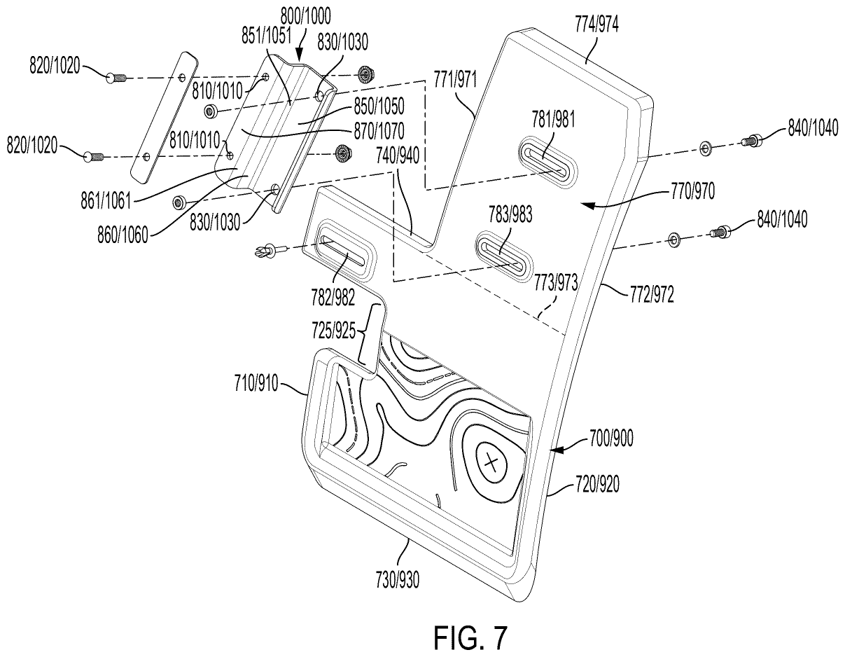

FIG. 6 illustrates an isometric view of the front passenger side mud flap (700) in assembled form with FIG. 7 illustrating various components of the front passenger side mud flap separated from one another. While FIGS. 6 and 7 illustrate the front passenger side mud flap, one will recognize that the front drive side mud flap (900) is substantially similar to the front passenger side mud flap and includes the same components in a reversed or mirrored configuration. Accordingly, FIGS. 6 and 7 are labelled with numbers corresponding to either the front passenger side mud flap or the front drive side mud flap.

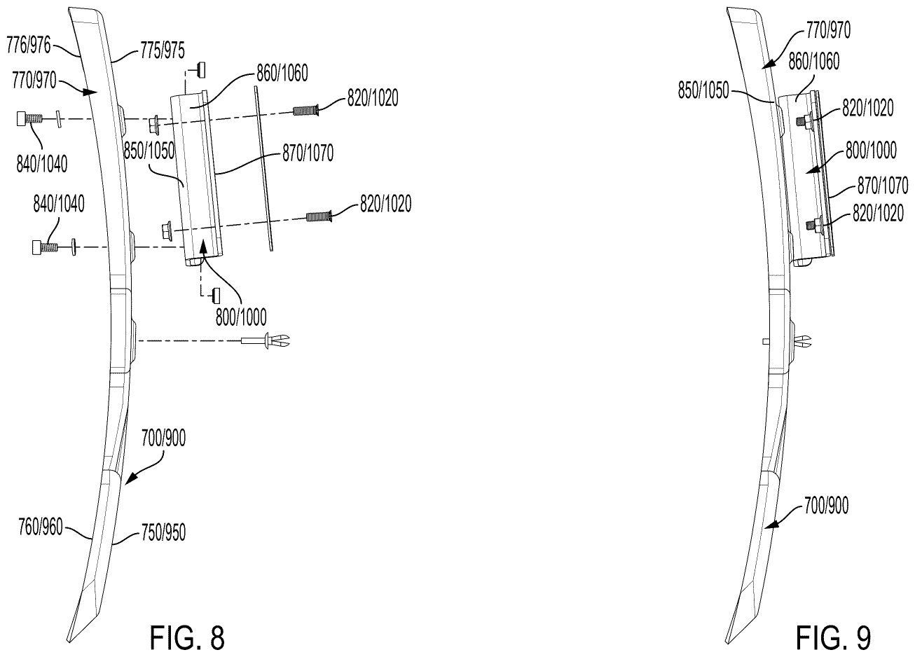

As shown in FIGS. 6 and 7, the front passenger side mud flap (700) has a front passenger side mud flap interior edge (710) and a front passenger side mud flap exterior edge (720) opposite the front passenger side mud flap interior edge. Extending between the front passenger side mud flap interior edge and the front passenger side mud flap exterior edge at a bottom end thereof is a front passenger side mud flap lower end (730) while a front passenger side mud flap upper end (740) is opposite the front passenger side mud flap lower end. The front passenger side mud flap interior edge, front passenger side mud flap exterior edge, front passenger side mud flap lower end, and front passenger side mud flap upper end form a front passenger side mud flap plane defining a front passenger side mud flap outer surface ((750) as shown in FIG. 8) and a front passenger side mud flap inner surface ((760) as shown in FIG. 8). Extending from the front passenger side mud flap interior edge towards the front passenger side mud flap exterior edge between the front passenger side mud flap lower end and the front passenger side mud flap upper end is a front passenger side mud flap recess (725).

Extending from a portion of the front passenger side mud flap upper end (740) is a front passenger side mud flap mounting extension (770). The front passenger side mud flap mounting extension having a front passenger side extension interior edge (771) and a front passenger side extension exterior edge (772) opposite the front passenger side extension interior edge. Extending between the front passenger side extension interior edge and the front passenger side extension exterior edge at a bottom end thereof is a front passenger side extension lower end (773) while a front passenger side extension upper end (774) is opposite the front passenger side extension lower end. The front passenger side extension interior edge, front passenger side extension exterior edge, front passenger side extension lower end, and front passenger side extension upper end form a front passenger side extension plane defining a front passenger side extension outer surface ((775) as shown in FIG. 8) and a front passenger side extension inner surface ((776) as shown in FIG. 8).

The front passenger side mud flap (700) further includes a plurality of front passenger side mud flap mounting slots (780). In some embodiments, the plurality of front passenger side mud flap mounting slots may include at least a front passenger side mud flap upper mounting slot (781), a front passenger side mud flap lower mounting slot (782), and a front passenger side mud flap central mounting slot (783). When present, the front passenger side mud flap upper mounting slot will pass from the front passenger side extension outer surface through the front passenger side extension inner surface. When present, the front passenger side mud flap lower mounting slot will pass from the front passenger side mud flap outer surface through the front passenger side mud flap inner surface. When present, the front passenger side mud flap central mounting slot will pass from the front passenger side extension outer surface through the front passenger side extension inner surface between the front passenger side mud flap upper mounting slot and the front passenger side mud flap lower mounting slot.

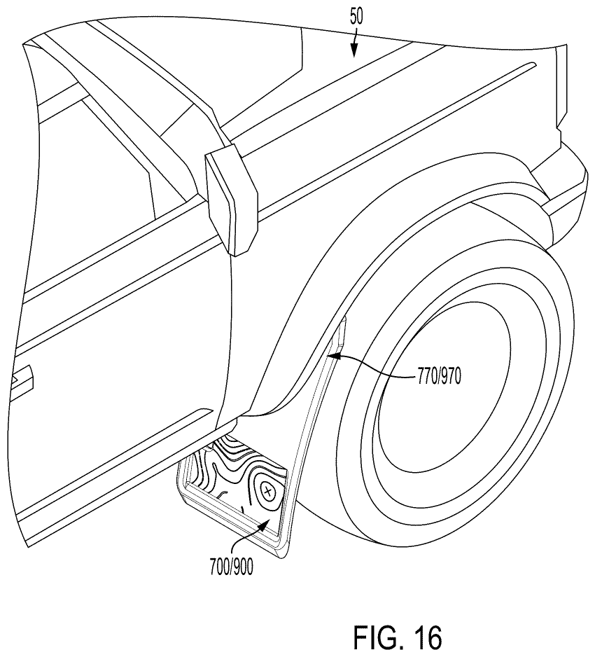

The front passenger side mud flap mounting slots (780) serve as an adjustable mounting point for connecting a front passenger side mounting bracket (800) to the front passenger side mud flap (700). The front passenger side mounting bracket including at least one front passenger side bracket vehicle connection hole (810) and at least one front passenger side extension connection hole (830). The front passenger side bracket vehicle connection hole(s) being configured to connect the front passenger side mounting bracket to a vehicle fifth surface ((55) as shown in FIG. 15) by an eleventh fastener (820). The front passenger side extension connection hole(s) being configured to connect the front passenger side mounting bracket to the front passenger side mud flap mounting extension by a twelfth fastener (840) passing through the front passenger side mud flap upper mounting slot or the front passenger side mud flap central mounting slot and into the front passenger side extension connection hole.

FIG. 6 and FIG. 7 also illustrate an exemplary embodiment of the front passenger side mounting bracket (800). As shown in FIG. 6 and FIG. 7, the exemplary embodiment of the front passenger side mounting bracket may include a front passenger side mounting bracket main plate (850), a front passenger side mounting bracket lip (860), and a front passenger side mounting bracket tab (870). When present, the front passenger side mounting bracket main plate may include at least one of the front passenger side extension connection holes (830) passing therethrough. The front passenger side mounting bracket lip may extend outward from a front passenger side mounting bracket main plate first edge (851) while the front passenger side mounting bracket tab may extend inward from a front passenger side mounting bracket lip first edge (861). At least one of the front passenger side bracket vehicle connection holes may pass through the front passenger side mounting bracket tab.

As previously noted, the front drive side mud flap (900) may be substantially similar to the front passenger side mud flap (700) and may include the same components in a reversed or mirrored configuration. Accordingly, as shown in FIGS. 6 and 7, the front drive side mud flap has a front drive side mud flap interior edge (910) and a front drive side mud flap exterior edge (920) opposite the front drive side mud flap interior edge. Extending between the front drive side mud flap interior edge and the front drive side mud flap exterior edge at a bottom end thereof is a front drive side mud flap lower end (930) while a front drive side mud flap upper end (940) is opposite the front drive side mud flap lower end. The front drive side mud flap interior edge, front drive side mud flap exterior edge, front drive side mud flap lower end, and front drive side mud flap upper end form a front drive side mud flap plane defining a front drive side mud flap outer surface ((950) as shown in FIG. 8) and a front drive side mud flap inner surface ((960) as shown in FIG. 8). Extending from the front drive side mud flap interior edge towards the front drive side mud flap exterior edge between the front drive side mud flap lower end and the front drive side mud flap upper end is a front drive side mud flap recess (925).

Extending from a portion of the front drive side mud flap upper end (940) is a front drive side mud flap mounting extension (970). The front drive side mud flap mounting extension having a front drive side extension interior edge (971) and a front drive side extension exterior edge (972) opposite the front drive side extension interior edge. Extending between the front drive side extension interior edge and the front drive side extension exterior edge at a bottom end thereof is a front drive side extension lower end (973) while a front drive side extension upper end (974) is opposite the front drive side extension lower end. The front drive side extension interior edge, front drive side extension exterior edge, front drive side extension lower end, and front drive side extension upper end form a front drive side extension plane defining a front drive side extension outer surface ((975) as shown in FIG. 8) and a front drive side extension inner surface ((976) as shown in FIG. 8).

The front drive side mud flap (900) further includes a plurality of front drive side mud flap mounting slots (980). In some embodiments, the plurality of front drive side mud flap mounting slots may include at least a front drive side mud flap upper mounting slot (981), a front drive side mud flap lower mounting slot (982), and a front drive side mud flap central mounting slot (983). When present, the front drive side mud flap upper mounting slot will pass from the front drive side extension outer surface through the front drive side extension inner surface. When present, the front drive side mud flap lower mounting slot will pass from the front drive side mud flap outer surface through the front drive side mud flap inner surface. When present, the front drive side mud flap central mounting slot will pass from the front drive side extension outer surface through the front drive side extension inner surface between the front drive side mud flap upper mounting slot and the front drive side mud flap lower mounting slot.

The front drive side mud flap mounting slots (980) serve as an adjustable mounting point for connecting a front drive side mounting bracket (1000) to the front drive side mud flap (900). The front drive side mounting bracket including at least one front drive side bracket vehicle connection hole (1010) and at least one front drive side extension connection hole (1030). The front drive side bracket vehicle connection hole(s) being configured to connect the front drive side mounting bracket to a vehicle sixth surface ((56) as shown in FIG. 15) by a thirteenth fastener (1020). The front drive side extension connection hole(s) being configured to connect the front drive side mounting bracket to the front drive side mud flap mounting extension by a fourteenth fastener (1040) passing through the front drive side mud flap upper mounting slot or the front drive side mud flap central mounting slot and into the front drive side extension connection hole.

FIG. 6 and FIG. 7 also illustrate an exemplary embodiment of the front drive side mounting bracket (1000). As shown in FIG. 6 and FIG. 7, the exemplary embodiment of the front drive side mounting bracket may include a front drive side mounting bracket main plate (1050), a front drive side mounting bracket lip (1060), and a front drive side mounting bracket tab (1070). When present, the front drive side mounting bracket main plate may include at least one of the front drive side extension connection holes (1030) passing therethrough. The front drive side mounting bracket lip may extend outward from a front drive side mounting bracket main plate first edge (1051) while the front drive side mounting bracket tab may extend inward from a front drive side mounting bracket lip first edge (1061). At least one of the front drive side bracket vehicle connection holes (1010) may pass through the front drive side mounting bracket tab.

FIGS. 8 and 9 illustrate the front passenger side mud flap (700) or the front drive side mud flap (900) respectively from a side view with FIG. 8 showing an exploded view and FIG. 9 showing an assembled view. As shown in FIGS. 8 and 9, the front passenger side mounting bracket (800) may be connected to the front passenger side extension outer surface (775) by the twelfth fastener (840) passing through the front passenger side mud flap upper mounting slot ((781) as shown in FIG. 7) and into the front passenger side extension connection hole ((830) as shown in FIG. 7) or passing through the front passenger side mud flap central mounting slot ((783) as shown in FIG. 7) and into the front passenger side extension connection hole. While FIGS. 8 and 9 illustrate the front passenger side mounting bracket connected to the front passenger side extension outer surface, embodiments may exist in which the front passenger side mounting bracket connects to the front passenger side extension inner surface (776). As the connection between the front passenger side mounting bracket and the front passenger side mud flap involves the twelfth fastener passing through at least one of the front passenger side mud flap mounting slots ((780 as shown in FIG. 6), the position of the front passenger side mounting bracket along the width of the front passenger side mud flap may be adjusted by loosening the twelfth fastener and sliding the front passenger side mounting bracket along the width of the mud flap before retightening the twelfth fastener. In doing so, the position of the front passenger side mud flap within the right front wheel well may be adjusted to suit an individual's needs and aesthetic preferences.

While the Figures illustrate slots in the front passenger side mud flap (700) and/or the front passenger side mud flap mounting extension (770) with holes in the front passenger side mounting bracket (800), other embodiments may exist in which the configuration is reversed. For example, one or more of the front passenger side mud flap mounting slots (780) may be replaced by a front passenger side mud flap mounting hole while the corresponding front passenger side extension connection hole(s) (830) may be replaced by front passenger side extension connection slot(s).

As previously noted, the front drive side mud flap (900) may be substantially similar to the front passenger side mud flap (700) and may include the same components in a reversed or mirrored configuration. Accordingly, as shown in FIGS. 8 and 9, the front drive side mounting bracket (1000) may be connected to the front drive side extension outer surface (975) by the fourteenth fastener (1040) passing through the front drive side mud flap upper mounting slot ((981) as shown in FIG. 7) and into the front drive side extension connection hole ((1030) as shown in FIG. 7) or passing through the front drive side mud flap central mounting slot ((983) as shown in FIG. 7) and into the front drive side extension connection hole. While FIGS. 8 and 9 illustrate the front drive side mounting bracket connected to the front drive side extension outer surface, embodiments may exist in which the front drive side mounting bracket connects to the front drive side extension inner surface (976). As the connection between the front drive side mounting bracket and the front drive side mud flap involves the fourteenth fastener passing through at least one of the front drive side mud flap mounting slots ((980 as shown in FIG. 6), the position of the front drive side mounting bracket along the width of the front drive side mud flap may be adjusted by loosening the fourteenth fastener and sliding the front drive side mounting bracket along the width of the mud flap before retightening the fourteenth fastener. In doing so, the position of the front drive side mud flap within the left front wheel well may be adjusted to suit an individual's needs and aesthetic preferences.

While the Figures illustrate slots in the front drive side mud flap (900) and/or the front drive side mud flap mounting extension (970) with holes in the front drive side mounting bracket (1000), other embodiments may exist in which the configuration is reversed. For example, one or more of the front drive side mud flap mounting slots (980) may be replaced by a front drive side mud flap mounting hole while the corresponding front drive side extension connection hole(s) (1030) may be replaced by front drive side extension connection slot(s).

The fasteners described herein may be of any type commonly used to affix one component to another. Examples of such fasteners include a bolt and nut, a screw, a rivet, a clamp, a pin, or the like. When the fastener includes a bolt, the bolt may have any number of different types of bolt heads including a hex head, an allen head, or the like.

FIG. 10 illustrates an exemplary embodiment of the mud flap system (10) and a vehicle (50) to which one or more of the individual mud flaps may be connected. As shown in FIG. 10, the rear passenger side mud flap (100) is configured to connect to the rear passenger (or “right rear”) wheel well behind the rear passenger tire. The rear driver side mud flap (400) is configured to connect to the rear driver (or “left rear”) wheel well behind the rear driver tire. The front passenger side mud flap (700) is configured to connect to the front passenger (or “right front”) wheel well behind the front passenger tire. The front drive side mud flap (900) is configured to connect to the front driver (or “left front”) wheel well behind the front driver tire.

FIG. 11 illustrates an exemplary embodiment of connecting the rear passenger side mud flap (100) to the rear passenger wheel well of the vehicle (50) in exploded view with FIG. 12 illustrating the assembled version thereof. As shown in FIGS. 11 and 12, the rear passenger side mud flap upper mounting bracket (200) is configured to connect the rear passenger side mud flap to the vehicle at the vehicle first surface (51) while the rear passenger side central mounting bracket assembly (300) is configured to connect the rear passenger side mud flap to the vehicle at the vehicle second surface (52). The vehicle first surface and/or the vehicle second surface may be a substantially planar surface of the wheel well and/or a structural surface of the wheel well or the chassis of the vehicle.

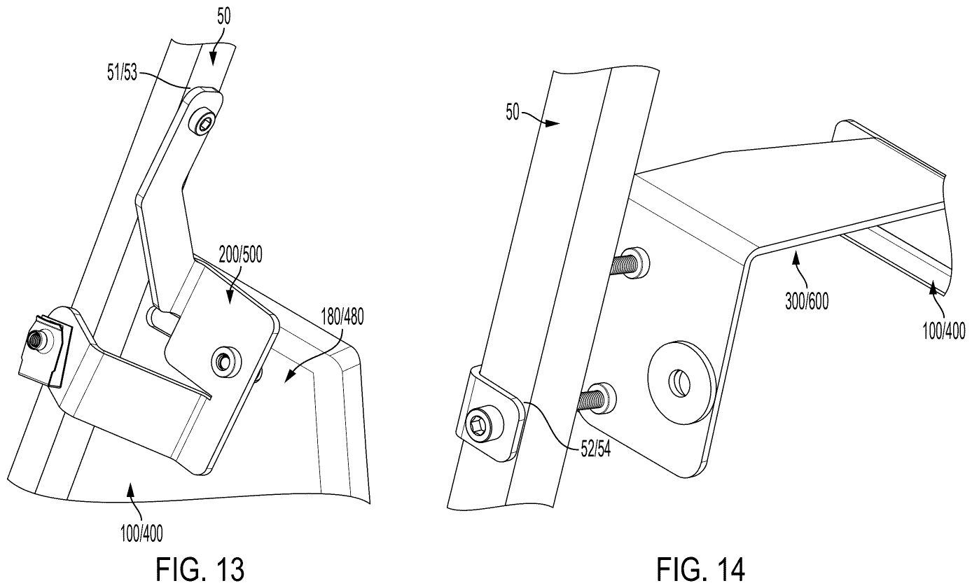

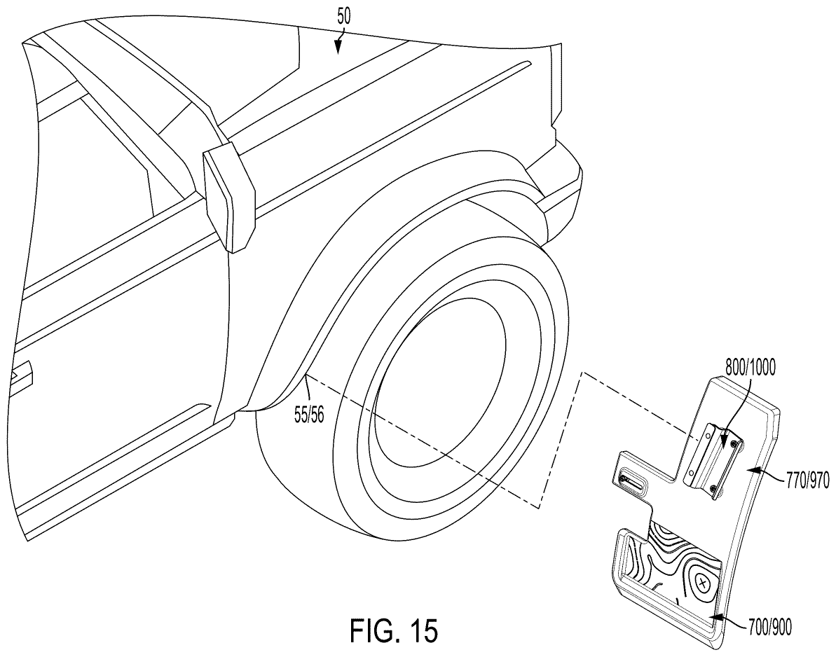

FIG. 13 illustrates a close-up view of the rear passenger side mud flap upper mounting bracket (200) connecting the rear passenger side mud flap (100) to the vehicle first surface (51) which in this case is illustrated as a wheel well brace. FIG. 14 illustrates a close-up view of the rear passenger side central mounting bracket assembly (300) connecting the rear passenger side mud flap to the vehicle second surface (52) which is also illustrated as a wheel well brace.

As previously noted, the rear driver side mud flap (400) may be substantially similar to the rear passenger side mud flap (100) and may include the same components in a reversed or mirrored configuration. Accordingly, as shown in FIGS. 11 to 14, the rear driver side mud flap upper mounting bracket (500) is configured to connect the rear driver side mud flap to the vehicle (50) at the vehicle third surface (53) while the rear driver side central mounting bracket assembly (600) is configured to connect the rear driver side mud flap to the vehicle at the vehicle fourth surface (54). The vehicle third surface and/or the vehicle fourth surface may be a substantially planar surface of the wheel well and/or a structural surface of the wheel well or the chassis of the vehicle. FIG. 13 may also be thought of as illustrating a close-up view of the rear driver side mud flap upper mounting bracket connecting the rear driver side mud flap to the vehicle third surface which in this case is illustrated as a wheel well brace. FIG. 14 may also be thought of as illustrating a close-up view of the rear driver side central mounting bracket assembly connecting the rear driver side mud flap to the vehicle fourth surface which is also illustrated as a wheel well brace.

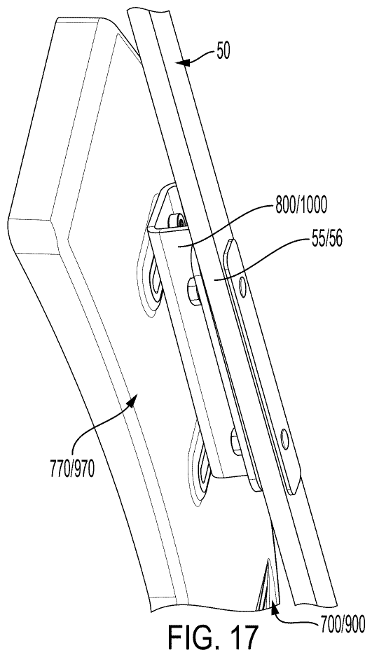

FIG. 15 illustrates an exemplary embodiment of connecting the front passenger side mud flap (700) to the front passenger wheel well of the vehicle (50) in exploded view with FIG. 16 illustrating the assembled version thereof. As shown in FIGS. 15 and 16, the front passenger side mounting bracket (800) is configured to connect the front passenger side mud flap to the vehicle at the vehicle fifth surface (55). The vehicle fifth surface may be a substantially planar surface of the wheel well and/or a structural surface of the wheel well or the chassis of the vehicle. FIG. 17 illustrates a close-up view of the front passenger side mounting bracket connecting the front passenger side mud flap to the vehicle fifth surface which in this case is illustrated as a wheel well brace.

As previously noted, the front drive side mud flap (900) may be substantially similar to the front passenger side mud flap (700) and may include the same components in a reversed or mirrored configuration. Accordingly, as shown in FIGS. 15 through 17, the front drive side mounting bracket (1000) is configured to connect the front drive side mud flap to the vehicle at the vehicle sixth surface (56). The vehicle sixth surface may be a substantially planar surface of the wheel well and/or a structural surface of the wheel well or the chassis of the vehicle. FIG. 17 may be thought of as illustrating a close-up view of the front drive side mounting bracket connecting the front drive side mud flap to the vehicle sixth surface which in this case is illustrated as a wheel well brace.

The mud flap system (10) may also be provided as a mud flap kit comprising any number of combinations of the embodiments of the rear passenger side mud flap (100), the rear passenger side mud flap upper mounting bracket (200), the rear passenger side central mounting bracket assembly (300), the rear driver side mud flap (400), the rear driver side mud flap upper mounting bracket (500), the rear driver side mud flap central mounting bracket (600), the front passenger side mud flap (700), the front passenger side mounting bracket (800), the front drive side mud flap (900), and the front drive side mounting bracket (1000) disclosed herein.

The various components of the mud flap system disclosed herein—including components of the mud flaps and the mounting brackets—may be manufactured using any number of different materials and any number of different manufacturing techniques. Preferably, the various components will be manufactured of a metal material such as steel, stainless steel, aluminum, or the like. However, embodiments may exist in which one or more of the components—in particular the mud flaps—may be manufactured of a rigid plastic material such as acrylonitrile butadiene styrene (ABS), polyethylene (PE), nylon, and the like. Manufacturing techniques may include cutting, bending, grinding, welding, casting, forging, injection molding, and the like using common equipment for conducting such operations.

The slotted mounting of the mud flaps disclosed herein allows the mud flaps to be adjusted within the vehicle's wheel well to a position in which they are substantially aligned with the tire. This is considered particularly beneficial in applications where the vehicle has received aftermarket tire, wheel, and/or suspension upgrades which align the rotating wheel in a different position within the wheel well than what is typically provided by the OEM. In doing so, the mud flaps disclosed herein block more of the water, mud, dirt, stones, and other debris dispersed by the rotating tire from impacting the vehicle's body panels and/or being dispersed behind the vehicle into traffic while avoiding mud build-up on the inside of the wheel well. The mud flaps disclosed herein also provide an improved fit with vehicles having rock rails due to an inverted detent in the design. The mud flap system is also considered an improvement over existing mud flaps in that it may be installed onto a vehicle with minimal—often no—additional modifications needed to the vehicle such as the drilling of holes into the wheel well or the vehicle's chassis. This is particularly the case for sixth generation models of the Ford® Bronco@ for which the mud flaps may be optimized—including those models having metal or plastic bumpers, and those models having a wider SAS.

While the mud flap system has been described as having one or more exemplary designs, the present article may be further modified within the spirit and scope of this disclosure. This application is therefore intended to cover any variations, uses, or adaptations of the mud flap system using their general principles.

What is claimed is:

1. A mud flap system (10) for a vehicle (50), said mud flap system comprising:
a rear passenger side mud flap (100) comprising:
a rear passenger side mud flap interior edge (110), a rear passenger side mud flap exterior edge (120) opposite the rear passenger side mud flap interior edge, a rear passenger side mud flap lower end (130), and a rear passenger side mud flap upper end (140) opposite the rear passenger side mud flap lower end, said rear passenger side mud flap interior edge, rear passenger side mud flap exterior edge, rear passenger side mud flap lower end, and rear passenger side mud flap upper end forming a rear passenger side mud flap plane defining a rear passenger side mud flap outer surface (150) and a rear passenger side mud flap inner surface (160) opposite the rear passenger side mud flap outer surface;
a plurality of rear passenger side mud flap central mounting holes (170) passing from the rear passenger side mud flap outer surface through the rear passenger side mud flap inner surface along the rear passenger side mud flap upper end;
a rear passenger side mud flap mounting extension (180) extending from a portion of the rear passenger side mud flap upper end, said rear passenger side mud flap mounting extension having a rear passenger side extension interior edge (181), a rear passenger side extension exterior edge (182) opposite the rear passenger side extension interior edge, a rear passenger side extension lower end (183) connected to the rear passenger side mud flap upper end, and a rear passenger side extension upper end (184) opposite the rear passenger side extension lower end, said rear passenger side extension interior edge, rear passenger side extension exterior edge, rear passenger side extension lower end, and rear passenger side extension upper end forming a rear passenger side extension plane defining a rear passenger side extension outer surface (185) and a rear passenger side extension inner surface (186) opposite the rear passenger side extension outer surface; and
a rear passenger side mud flap mounting slot (190) passing from the rear passenger side extension outer surface through the rear passenger side extension inner surface along the rear passenger side extension upper end;
a rear passenger side mud flap upper mounting bracket (200) comprising at least one rear passenger side bracket vehicle connection hole (210) configured to connect the rear passenger side mud flap upper mounting bracket to a vehicle first surface (51) by a first fastener (220), and at least one rear passenger side extension connection hole (230) configured to connect the rear passenger side mud flap upper mounting bracket to the rear passenger side mud flap mounting extension by a second fastener (240) passing through the rear passenger side mud flap mounting slot and into the rear passenger side extension connection hole; and
a rear passenger side central mounting bracket assembly (300) comprising:
a rear passenger side mud flap attachment (310) comprising:
a plurality of rear passenger side mud flap connection holes (311) with each rear passenger side mud flap connection hole configured to connect the rear passenger side mud flap attachment to the rear passenger side mud flap by passing third fastener (312) through a rear passenger side mud flap connection hole of the plurality of rear passenger side mud flap connection holes and into a rear passenger side mud flap central mounting hole of the plurality of rear passenger side mud flap central mounting holes; and
at least one rear passenger side mud flap attachment slot (313); and
a rear passenger side vehicle attachment mechanism (320) comprising at least one rear passenger side vehicle connection hole (321) configured to connect the rear passenger side vehicle attachment mechanism to a vehicle second surface (52) by a fourth fastener (322), and at least one first vehicle attachment connection hole (323) configured to connect the rear passenger side vehicle attachment mechanism to the rear passenger side mud flap attachment by a fifth fastener (324) passing through the rear passenger side mud flap attachment slot and into the first vehicle attachment connection hole.

2. The mud flap system of claim 1, wherein the rear passenger side mud flap upper mounting bracket comprises:
a rear passenger side upper mounting bracket central plate (250) with the at least one rear passenger side extension connection hole passing through the rear passenger side upper mounting bracket central plate;
a rear passenger side upper mounting bracket lower arm (260) extending forward from a rear passenger side upper mounting bracket central plate first edge (251) at a rear passenger side upper mounting bracket central plate lower end (252);
a rear passenger side upper mounting bracket lower tab (270) extending inward from a rear passenger side upper mounting bracket lower arm terminal end (261) with a first of the at least one rear passenger side bracket vehicle connection hole passing through the rear passenger side upper mounting bracket lower tab;
a rear passenger side upper mounting bracket upper arm (280) extending forward from a rear passenger side upper mounting bracket central plate second edge (253) at a rear passenger side upper mounting bracket central plate upper end (254); and
a rear passenger side upper mounting bracket upper tab (290) extending upward from a rear passenger side upper mounting bracket upper arm terminal end (281) with a second of the at least one rear passenger side bracket vehicle connection hole passing through the rear passenger side upper mounting bracket upper tab.

3. The mud flap system of claim 1, wherein the rear passenger side vehicle attachment mechanism comprises:
a rear passenger side vehicle attachment central plate (325);
a rear passenger side vehicle attachment proximal plate (326) extending downward from a rear passenger side vehicle attachment central plate proximal edge with the at least one first vehicle attachment connection hole passing through the rear passenger side vehicle attachment proximal plate;
a rear passenger side vehicle attachment terminal plate (327) extending downward from a rear passenger side vehicle attachment central plate terminal edge with at least a first of the at least one rear passenger side vehicle connection hole passing through the rear passenger side vehicle attachment terminal plate;
a rear passenger side vehicle attachment arm (328) extending forward from a rear passenger side vehicle attachment terminal plate first edge at a rear passenger side vehicle attachment terminal plate lower end; and
a rear passenger side vehicle attachment tab (329) extending outward from a rear passenger side vehicle attachment arm terminal end with at least a second of the at least one rear passenger side vehicle connection hole passing through the rear passenger side vehicle attachment tab.

4. The mud flap system of claim 1, further comprising:
a rear driver side mud flap (400) comprising:
a rear driver side mud flap interior edge (410), a rear driver side mud flap exterior edge (420) opposite the rear driver side mud flap interior edge, a rear driver side mud flap lower end (430), and a rear driver side mud flap upper end (440) opposite the rear driver side mud flap lower end, said rear driver side mud flap interior edge, rear driver side mud flap exterior edge, rear driver side mud flap lower end, and rear driver side mud flap upper end forming a rear driver side mud flap plane defining a rear driver side mud flap outer surface (450) and a rear driver side mud flap inner surface (460) opposite the rear driver side mud flap outer surface;
a plurality of rear driver side mud flap central mounting holes (470) passing from the rear driver side mud flap outer surface through the rear driver side mud flap inner surface along the rear driver side mud flap upper end;
a rear driver side mud flap mounting extension (480) extending from a portion of the rear driver side mud flap upper end, said rear driver side mud flap mounting extension having a rear driver side extension interior edge (481), a rear driver side extension exterior edge (482) opposite the rear driver side extension interior edge, a rear driver side extension lower end (483) connected to the rear driver side mud flap upper end, and a rear driver side extension upper end (484) opposite the rear driver side extension lower end, said rear driver side extension interior edge, rear driver side extension exterior edge, rear driver side extension lower end, and rear driver side extension upper end forming a rear driver side extension plane defining a rear driver side extension outer surface (485) and a rear driver side extension inner surface (486) opposite the rear driver side extension outer surface; and
a rear driver side mud flap mounting slot (490) passing from the rear driver side extension outer surface through the rear driver side extension inner surface along the rear driver side extension upper end;
a rear driver side mud flap upper mounting bracket (500) comprising at least one rear driver side bracket vehicle connection hole (510) configured to connect the rear driver side mud flap upper mounting bracket to a vehicle third surface (53) by a sixth fastener (520), and at least one rear driver side extension connection hole (530) configured to connect the rear driver side mud flap upper mounting bracket to the rear driver side mud flap mounting extension by a seventh fastener (540) passing through the rear driver side mud flap mounting slot and into the rear driver side extension connection hole; and
a rear driver side central mounting bracket assembly (600) comprising:
a rear driver side mud flap attachment (610) comprising:
a plurality of rear driver side mud flap connection holes (611) with each rear driver side mud flap connection hole configured to connect the rear driver side mud flap attachment to the rear driver side mud flap by passing an eighth fastener (612) through a rear driver side mud flap connection hole of the plurality of rear driver side mud flap connection holes and into a rear driver side mud flap central mounting hole of the plurality of rear driver side mud flap central mounting holes; and
at least one rear driver side mud flap attachment slot (613); and
a rear driver side attachment mechanism (620) comprising at least one rear driver side connection hole (621) configured to connect he rear driver side attachment mechanism to a vehicle fourth surface (54) by a ninth fastener (622), and at least one rear driver side vehicle attachment connection hole (623) configured to connect the rear driver side attachment mechanism to the rear driver side mud flap attachment by a tenth fastener (624) passing through the rear driver side mud flap attachment slot and into the rear driver side vehicle attachment connection hole.

5. The mud flap system of claim 4, wherein the rear driver side mud flap upper mounting bracket comprises:
a rear driver side upper mounting bracket central plate (550) with the at least one rear driver side extension connection hole passing through the rear driver side upper mounting bracket central plate;
a rear driver side upper mounting bracket lower arm (560) extending forward from a rear driver side upper mounting bracket central plate first edge (551) at a rear driver side upper mounting bracket central plate lower end (552);
a rear driver side upper mounting bracket lower tab (570) extending inward from a rear driver side upper mounting bracket lower arm terminal end (561) with a first of the at least one rear driver side bracket vehicle connection hole passing through the rear driver side upper mounting bracket lower tab;
a rear driver side upper mounting bracket upper arm (580) extending forward from a rear driver side upper mounting bracket central plate second edge (553) at a rear driver side upper mounting bracket central plate upper end (554); and
a rear driver side upper mounting bracket upper tab (590) extending upward from a rear driver side upper mounting bracket upper arm terminal end (581) with at second of the at least one rear driver side bracket vehicle connection hole passing through the rear driver side upper mounting bracket upper tab.

6. The mud flap system of claim 4, wherein the rear driver side attachment mechanism comprises:
a rear driver side vehicle attachment central plate (625);
a rear driver side vehicle attachment proximal plate (626) extending downward from a rear driver side vehicle attachment central plate proximal edge with the at least one rear driver side vehicle attachment connection hole passing through the rear driver side vehicle attachment proximal plate;
a rear driver side vehicle attachment terminal plate (627) extending downward from a rear driver side vehicle attachment central plate terminal edge with at least a first of the at least one rear driver side connection hole passing through the rear driver side vehicle attachment terminal plate;
a rear driver side vehicle attachment arm (628) extending forward from a rear driver side vehicle attachment terminal plate first edge at a rear driver side vehicle attachment terminal plate lower end; and
a rear driver side vehicle attachment tab (629) extending outward from a rear driver side vehicle attachment arm terminal end with at least a second of the at least one rear driver side connection hole passing through the rear driver side vehicle attachment tab.

7. A mud flap system (10) for a vehicle (50), said mud flap system comprising:
a front passenger side mud flap (700) comprising:
a front passenger side mud flap interior edge (710), a front passenger side mud flap exterior edge (720) opposite the front passenger side mud flap interior edge, a front passenger side mud flap lower end (730), and a front passenger side mud flap upper end (740) opposite the front passenger side mud flap lower end, said front passenger side mud flap interior edge, front passenger side mud flap exterior edge, front passenger side mud flap lower end, and front passenger side mud flap upper end forming a front passenger side mud flap plane defining a front passenger side mud flap outer surface (750) and a front passenger side mud flap inner surface (760) opposite the front passenger side mud flap outer surface, and a front passenger side mud flap recess (725) extending from the front passenger side mud flap interior edge towards the front passenger side mud flap exterior edge between the front passenger side mud flap lower end and the front passenger side mud flap upper end;
a front passenger side mud flap mounting extension (770) extending from a portion of the front passenger side mud flap upper end said front passenger side mud flap mounting extension having a front passenger side extension interior edge (771), a front passenger side extension exterior edge (772) opposite the front passenger side extension interior edge, a front passenger side extension lower end (773) connected to the front passenger side mud flap upper end, and a front passenger side extension upper end (774) opposite the front passenger side extension lower end, said front passenger side extension interior edge, front passenger side extension exterior edge, front passenger side extension lower end, and front passenger side extension upper end forming a front passenger side extension plane defining a front passenger side extension outer surface (775) and a front passenger side extension inner surface (776) opposite the front passenger side extension outer surface; and
a plurality of front passenger side mud flap mounting slots (780) comprising at least:
a front passenger side mud flap upper mounting slot (781) passing from the front passenger side extension outer surface through the front passenger side extension inner surface;
a front passenger side mud flap lower mounting slot (782) passing from the front passenger side mud flap outer surface through the front passenger side mud flap inner surface; and
a front passenger side mud flap central mounting slot (783) passing from the front passenger side extension outer surface through the front passenger side extension inner surface between the front passenger side mud flap upper mounting slot and the front passenger side mud flap lower mounting slot; and
a front passenger side mounting bracket (800) comprising at least one front passenger side bracket vehicle connection hole (810) configured to connect the front passenger side mounting bracket to a vehicle fifth surface (55) by an eleventh fastener (820), and at least one front passenger side extension connection hole (830) configured to connect the front passenger side mounting bracket to the front passenger side mud flap mounting extension by a twelfth fastener (840) passing through the front passenger side mud flap upper mounting slot or the front passenger side mud flap central mounting slot and into the front passenger side extension connection hole.

8. The mud flap system of claim 7, wherein the front passenger side mounting bracket comprises:
a front passenger side mounting bracket main plate (850) with at least one of the front passenger side extension connection holes passing through the front passenger side mounting bracket main plate;
a front passenger side mounting bracket lip (860) extending outward from a front passenger side mounting bracket main plate first edge (851); and
a front passenger side mounting bracket tab (870) extending inward from a front passenger side mounting bracket lip first edge (861) with at least one of the front passenger side bracket vehicle connection holes passing through the front passenger side mounting bracket tab.

9. The mud flap system of claim 7, further comprising:
a front drive side mud flap (900) comprising:
a front drive side mud flap interior edge (910), a front drive side mud flap exterior edge (920) opposite the front drive side mud flap interior edge, a front drive side mud flap lower end (930), and a front drive side mud flap upper end (940) opposite the front drive side mud flap lower end, said front drive side mud flap interior edge, front drive side mud flap exterior edge, front drive side mud flap lower end, and front drive side mud flap upper end forming a front drive side mud flap plane defining a front drive side mud flap outer surface (950) and a front drive side mud flap inner surface (960) opposite the front drive side mud flap outer surface, and a front drive side mud flap recess (925) extending from the front drive side mud flap interior edge towards the front drive side mud flap exterior edge between the front drive side mud flap lower end and the front drive side mud flap upper end;
a front drive side mud flap mounting extension (970) extending from a portion of the front drive side mud flap upper end said front drive side mud flap mounting extension having a front drive side extension interior edge (971), a front drive side extension exterior edge (972) opposite the front drive side extension interior edge, a front drive side extension lower end (973) and a front drive side extension upper end (974) opposite the front drive side extension lower end, said front drive side extension interior edge, front drive side extension exterior edge, front drive side extension upper end, and front drive side extension lower end forming a front drive side extension plane defining a front drive side extension outer surface (975) and a front drive side extension inner surface (976) opposite the front drive side extension outer surface; and
a plurality of front drive side mud flap mounting slots (980) comprising at least:
a front drive side mud flap upper mounting slot (981) passing from the front drive side extension outer surface through the front drive side extension inner surface;
a front drive side mud flap lower mounting slot (982) passing from the front drive side mud flap outer surface through the front drive side mud flap inner surface; and
a front drive side mud flap central mounting slot (983) passing from the front drive side extension outer surface through the front drive side extension inner surface between the front drive side mud flap upper mounting slot and the front drive side mud flap lower mounting slot; and
a front drive side mounting bracket (1000) comprising at least one front drive side bracket vehicle connection hole (1010) configured to connect the front drive side mounting bracket to a vehicle sixth surface (56) by a thirteenth fastener (1020), and at least one front drive side extension connection hole (1030) configured to connect the front drive side mounting bracket to the front drive side mud flap mounting extension by a fourteenth fastener (1040) passing through the front drive side mud flap upper mounting slot or the front drive side mud flap central mounting slot and into the front drive side extension connection hole.

10. The mud flap system of claim 9, wherein the front drive side mounting bracket comprises:
a front drive side mounting bracket main plate (1050) with at least one of the front drive side extension connection holes passing through the front drive side mounting bracket main plate;
a front drive side mounting bracket lip (1060) extending outward from a front drive side mounting bracket main plate first edge (1051); and
a front drive side mounting bracket tab (1070) extending inward from a front drive side mounting bracket lip first edge (1061) with at least one of the front drive side bracket vehicle connection holes passing through the front drive side mounting bracket tab.

11. The mud flap system of claim 1, further comprising:
a front passenger side mud flap (700) comprising:
a front passenger side mud flap interior edge (710), a front passenger side mud flap exterior edge (720) opposite the front passenger side mud flap interior edge, a front passenger side mud flap lower end (730), and a front passenger side mud flap upper end (740) opposite the front passenger side mud flap lower end, said front passenger side mud flap interior edge, front passenger side mud flap exterior edge, front passenger side mud flap lower end, and front passenger side mud flap upper end forming a front passenger side mud flap plane defining a front passenger side mud flap outer surface (750) and a front passenger side mud flap inner surface (760) opposite the front passenger side mud flap outer surface, and a front passenger side mud flap recess (725) extending from the front passenger side mud flap interior edge towards the front passenger side mud flap exterior edge between the front passenger side mud flap lower end and the front passenger side mud flap upper end;
a front passenger side mud flap mounting extension (770) extending from a portion of the front passenger side mud flap upper end said front passenger side mud flap mounting extension having a front passenger side extension interior edge (771), a front passenger side extension exterior edge (772) opposite the front passenger side extension interior edge, a front passenger side extension lower end (773) connected to the front passenger side mud flap upper end, and a front passenger side extension upper end (774) opposite the front passenger side extension lower end, said front passenger side extension interior edge, front passenger side extension exterior edge, front passenger side extension lower end, and front passenger side extension upper end forming a front passenger side extension plane defining a front passenger side extension outer surface (775) and a front passenger side extension inner surface (776) opposite the front passenger side extension outer surface; and
a plurality of front passenger side mud flap mounting slots (780) comprising at least:
a front passenger side mud flap upper mounting slot (781) passing from the front passenger side extension outer surface through the front passenger side extension inner surface;
a front passenger side mud flap lower mounting slot (782) passing from the front passenger side mud flap outer surface through the front passenger side mud flap inner surface; and
a front passenger side mud flap central mounting slot (783) passing from the front passenger side extension outer surface through the front passenger side extension inner surface between the front passenger side mud flap upper mounting slot and the front passenger side mud flap lower mounting slot; and
a front passenger side mounting bracket (800) comprising at least one front passenger side bracket vehicle connection hole (810) configured to connect the front passenger side mounting bracket to a vehicle fifth surface (55) by an eleventh fastener (820), and at least one front passenger side extension connection hole (830) configured to connect the front passenger side mounting bracket to the front passenger side mud flap mounting extension by a twelfth fastener (840) passing through the front passenger side mud flap upper mounting slot or the front passenger side mud flap central mounting slot and into the front passenger side extension connection hole.

12. The mud flap system of claim 11, wherein the front passenger side mounting bracket comprises:
a front passenger side mounting bracket main plate (850) with at least one of the front passenger side extension connection holes passing through the front passenger side mounting bracket main plate;
a front passenger side mounting bracket lip (860) extending outward from a front passenger side mounting bracket main plate first edge (851); and
a front passenger side mounting bracket tab (870) extending inward from a front passenger side mounting bracket lip first edge (861) with at least one of the front passenger side bracket vehicle connection holes passing through the front passenger side mounting bracket tab.

13. The mud flap system of claim 11, further comprising:
a front drive side mud flap (900) comprising:
a front drive side mud flap interior edge (910), a front drive side mud flap exterior edge (920) opposite the front drive side mud flap interior edge, a front drive side mud flap lower end (930), and a front drive side mud flap upper end (940) opposite the front drive side mud flap lower end, said front drive side mud flap interior edge, front drive side mud flap exterior edge, front drive side mud flap lower end, and front drive side mud flap upper end forming a front drive side mud flap plane defining a front drive side mud flap outer surface (950) and a front drive side mud flap inner surface (960) opposite the front drive side mud flap outer surface, and a front drive side mud flap recess (925) extending from the front drive side mud flap interior edge towards the front drive side mud flap exterior edge between the front drive side mud flap lower end and the front drive side mud flap upper end;
a front drive side mud flap mounting extension (970) extending from a portion of the front drive side mud flap upper end said front drive side mud flap mounting extension having a front drive side extension interior edge (971), a front drive side extension exterior edge (972) opposite the front drive side extension interior edge, a front drive side extension lower end (973) and a front drive side extension upper end (974) opposite the front drive side extension lower end, said front drive side extension interior edge, front drive side extension exterior edge, front drive side extension upper end, and front drive side extension lower end forming a front drive side extension plane defining a front drive side extension outer surface (975) and a front drive side extension inner surface (976) opposite the front drive side extension outer surface; and
a plurality of front drive side mud flap mounting slots (980) comprising at least:
a front drive side mud flap upper mounting slot (981) passing from the front drive side extension outer surface through the front drive side extension inner surface;
a front drive side mud flap lower mounting slot (982) passing from the front drive side mud flap outer surface through the front drive side mud flap inner surface; and
a front drive side mud flap central mounting slot (983) passing from the front drive side extension outer surface through the front drive side extension inner surface between the front drive side mud flap upper mounting slot and the front drive side mud flap lower mounting slot; and
a front drive side mounting bracket (1000) comprising at least one front drive side bracket vehicle connection hole (1010) configured to connect the front drive side mounting bracket to a vehicle sixth surface (56) by a thirteenth fastener (1020), and at least one front drive side extension connection hole (1030) configured to connect the front drive side mounting bracket to the front drive side mud flap mounting extension by a fourteenth fastener (1040) passing through the front drive side mud flap upper mounting slot or the front drive side mud flap central mounting slot and into the front drive side extension connection hole.

14. The mud flap system of claim 13, wherein the front drive side mounting bracket comprises:
a front drive side mounting bracket main plate (1050) with at least one of the front drive side extension connection holes passing through the front drive side mounting bracket main plate;
a front drive side mounting bracket lip (1060) extending outward from a front drive side mounting bracket main plate first edge (1051); and
a front drive side mounting bracket tab (1070) extending inward from a front drive side mounting bracket lip first edge (1061) with at least one of the front drive side bracket vehicle connection holes passing through the front drive side mounting bracket tab.

15. The mud flap system of claim 4, further comprising:
a front passenger side mud flap (700) comprising:
a front passenger side mud flap interior edge (710), a front passenger side mud flap exterior edge (720) opposite the front passenger side mud flap interior edge, a front passenger side mud flap lower end (730), and a front passenger side mud flap upper end (740) opposite the front passenger side mud flap lower end, said front passenger side mud flap interior edge, front passenger side mud flap exterior edge, front passenger side mud flap lower end, and front passenger side mud flap upper end forming a front passenger side mud flap plane defining a front passenger side mud flap outer surface (750) and a front passenger side mud flap inner surface (760) opposite the front passenger side mud flap outer surface, and a front passenger side mud flap recess (725) extending from the front passenger side mud flap interior edge towards the front passenger side mud flap exterior edge between the front passenger side mud flap lower end and the front passenger side mud flap upper end;
a front passenger side mud flap mounting extension (770) extending from a portion of the front passenger side mud flap upper end said front passenger side mud flap mounting extension having a front passenger side extension interior edge (771), a front passenger side extension exterior edge (772) opposite the front passenger side extension interior edge, a front passenger side extension lower end (773) connected to the front passenger side mud flap upper end, and a front passenger side extension upper end (774) opposite the front passenger side extension lower end, said front passenger side extension interior edge, front passenger side extension exterior edge, front passenger side extension lower end, and front passenger side extension upper end forming a front passenger side extension plane defining a front passenger side extension outer surface (775) and a front passenger side extension inner surface (776) opposite the front passenger side extension outer surface; and
a plurality of front passenger side mud flap mounting slots (780) comprising at least:
a front passenger side mud flap upper mounting slot (781) passing from the front passenger side extension outer surface through the front passenger side extension inner surface;
a front passenger side mud flap lower mounting slot (782) passing from the front passenger side mud flap outer surface through the front passenger side mud flap inner surface; and
a front passenger side mud flap central mounting slot (783) passing from the front passenger side extension outer surface through the front passenger side extension inner surface between the front passenger side mud flap upper mounting slot and the front passenger side mud flap lower mounting slot; and
a front passenger side mounting bracket (800) comprising at least one front passenger side bracket vehicle connection hole (810) configured to connect the front passenger side mounting bracket to a vehicle fifth surface (55) by an eleventh fastener (820), and at least one front passenger side extension connection hole (830) configured to connect the front passenger side mounting bracket to the front passenger side mud flap mounting extension by a twelfth fastener (840) passing through the front passenger side mud flap upper mounting slot or the front passenger side mud flap central mounting slot and into the front passenger side extension connection hole.

16. The mud flap system of claim 15, wherein the front passenger side mounting bracket comprises:
a front passenger side mounting bracket main plate (850) with at least one of the front passenger side extension connection holes passing through the front passenger side mounting bracket main plate;
a front passenger side mounting bracket lip (860) extending outward from a front passenger side mounting bracket main plate first edge (851); and
a front passenger side mounting bracket tab (870) extending inward from a front passenger side mounting bracket lip first edge (861) with at least one of the front passenger side bracket vehicle connection holes passing through the front passenger side mounting bracket tab.

17. The mud flap system of claim 15, further comprising:
a front drive side mud flap (900) comprising:
a front drive side mud flap interior edge (910), a front drive side mud flap exterior edge (920) opposite the front drive side mud flap interior edge, a front drive side mud flap lower end (930), and a front drive side mud flap upper end (940) opposite the front drive side mud flap lower end, said front drive side mud flap interior edge, front drive side mud flap exterior edge, front drive side mud flap lower end, and front drive side mud flap upper end forming a front drive side mud flap plane defining a front drive side mud flap outer surface (950) and a front drive side mud flap inner surface (960) opposite the front drive side mud flap outer surface, and a front drive side mud flap recess (925) extending from the front drive side mud flap interior edge towards the front drive side mud flap exterior edge between the front drive side mud flap lower end and the front drive side mud flap upper end;
a front drive side mud flap mounting extension (970) extending from a portion of the front drive side mud flap upper end said front drive side mud flap mounting extension having a front drive side extension interior edge (971), a front drive side extension exterior edge (972) opposite the front drive side extension interior edge, a front drive side extension lower end (973) and a front drive side extension upper end (974) opposite the front drive side extension lower end, said front drive side extension interior edge, front drive side extension exterior edge, front drive side extension upper end, and front drive side extension lower end forming a front drive side extension plane defining a front drive side extension outer surface (975) and a front drive side extension inner surface (976) opposite the front drive side extension outer surface; and
a plurality of front drive side mud flap mounting slots (980) comprising at least:
a front drive side mud flap upper mounting slot (981) passing from the front drive side extension outer surface through the front drive side extension inner surface;
a front drive side mud flap lower mounting slot (982) passing from the front drive side mud flap outer surface through the front drive side mud flap inner surface; and
a front drive side mud flap central mounting slot (983) passing from the front drive side extension outer surface through the front drive side extension inner surface between the front drive side mud flap upper mounting slot and the front drive side mud flap lower mounting slot; and
a front drive side mounting bracket (1000) comprising at least one front drive side bracket vehicle connection hole (1010) configured to connect the front drive side mounting bracket to a vehicle sixth surface (56) by a thirteenth fastener (1020), and at least one front drive side extension connection hole (1030) configured to connect the front drive side mounting bracket to the front drive side mud flap mounting extension by a fourteenth fastener (1040) passing through the front drive side mud flap upper mounting slot or the front drive side mud flap central mounting slot and into the front drive side extension connection hole.

18. The mud flap system of claim 17, wherein the front drive side mounting bracket comprises:
a front drive side mounting bracket main plate (1050) with at least one of the front drive side extension connection holes passing through the front drive side mounting bracket main plate;
a front drive side mounting bracket lip (1060) extending outward from a front drive side mounting bracket main plate first edge (1051); and
a front drive side mounting bracket tab (1070) extending inward from a front drive side mounting bracket lip first edge (1061) with at least one of the front drive side bracket vehicle connection holes passing through the front drive side mounting bracket tab.

19. A mud flap kit comprising:
a rear passenger side mud flap (100) comprising:
a rear passenger side mud flap interior edge (110), a rear passenger side mud flap exterior edge (120) opposite the rear passenger side mud flap interior edge, a rear passenger side mud flap lower end (130), and a rear passenger side mud flap upper end (140) opposite the rear passenger side mud flap lower end, said rear passenger side mud flap interior edge, rear passenger side mud flap exterior edge, rear passenger side mud flap lower end, and rear passenger side mud flap upper end forming a rear passenger side mud flap plane defining a rear passenger side mud flap outer surface (150) and a rear passenger side mud flap inner surface (160) opposite the rear passenger side mud flap outer surface;
a plurality of rear passenger side mud flap central mounting holes (170) passing from the rear passenger side mud flap outer surface through the rear passenger side mud flap inner surface along the rear passenger side mud flap upper end;
a rear passenger side mud flap mounting extension (180) extending from a portion of the rear passenger side mud flap upper end, said rear passenger side mud flap mounting extension having a rear passenger side extension interior edge (181), a rear passenger side extension exterior edge (182) opposite the rear passenger side extension interior edge, a rear passenger side extension lower end (183) connected to the rear passenger side mud flap upper end, and a rear passenger side extension upper end (184) opposite the rear passenger side extension lower end, said rear passenger side extension interior edge, rear passenger side extension exterior edge, rear passenger side extension lower end, and rear passenger side extension upper end forming a rear passenger side extension plane defining a rear passenger side extension outer surface (185) and a rear passenger side extension inner surface (186) opposite the rear passenger side extension outer surface;
a rear passenger side mud flap mounting slot (190) passing from the rear passenger side extension outer surface through the rear passenger side extension inner surface along the rear passenger side extension upper end;
a rear passenger side mud flap upper mounting bracket (200) comprising at least one rear passenger side bracket vehicle connection hole (210) configured to connect the rear passenger side mud flap upper mounting bracket to a vehicle first surface (51) by a first fastener (220), and at least one rear passenger side extension connection hole (230) configured to connect the rear passenger side mud flap upper mounting bracket to the rear passenger side mud flap mounting extension by a second fastener (240) passing through the rear passenger side mud flap mounting slot and into the rear passenger side extension connection hole; and
a rear passenger side central mounting bracket assembly (300) comprising:
a rear passenger side mud flap attachment (310) comprising:
a plurality of rear passenger side mud flap connection holes (311) with each rear passenger side mud flap connection hole configured to connect the rear passenger side mud flap attachment to the rear passenger side mud flap by passing third fastener (312) through a rear passenger side mud flap connection hole of the plurality of rear passenger side mud flap connection holes and into a rear passenger side mud flap central mounting hole of the plurality of rear passenger side mud flap central mounting holes; and
at least one rear passenger side mud flap attachment slot (313); and
a rear passenger side vehicle attachment mechanism (320) comprising at least one rear passenger side vehicle connection hole (321) configured to connect the rear passenger side vehicle attachment mechanism to a vehicle second surface (52) by a fourth fastener (322), and at least one first vehicle attachment connection hole (323) configured to connect the rear passenger side vehicle attachment mechanism to the rear passenger side mud flap attachment by a fifth fastener (324) passing through the rear passenger side mud flap attachment slot and into the first vehicle attachment connection hole
a rear driver side mud flap (400) comprising:
a rear driver side mud flap interior edge (410), a rear driver side mud flap exterior edge (420) opposite the rear driver side mud flap interior edge, a rear driver side mud flap lower end (430), and a rear driver side mud flap upper end (440) opposite the rear driver side mud flap lower end, said rear driver side mud flap interior edge, rear driver side mud flap exterior edge, rear driver side mud flap lower end, and rear driver side mud flap upper end forming a rear driver side mud flap plane defining a rear driver side mud flap outer surface (450) and a rear driver side mud flap inner surface (460) opposite the rear driver side mud flap outer surface;
a plurality of rear driver side mud flap central mounting holes (470) passing from the rear driver side mud flap outer surface through the rear driver side mud flap inner surface along the rear driver side mud flap upper end;
a rear driver side mud flap mounting extension (480) extending from a portion of the rear driver side mud flap upper end, said rear driver side mud flap mounting extension having a rear driver side extension interior edge (481), a rear driver side extension exterior edge (482) opposite the rear driver side extension interior edge, a rear driver side extension lower end (483) connected to the rear driver side mud flap upper end, and a rear driver side extension upper end (484) opposite the rear driver side extension lower end, said rear driver side extension interior edge, rear driver side extension exterior edge, rear driver side extension lower end, and rear driver side extension upper end forming a rear driver side extension plane defining a rear driver side extension outer surface (485) and a rear driver side extension inner surface (486) opposite the rear driver side extension outer surface; and
a rear driver side mud flap mounting slot (490) passing from the rear driver side extension outer surface through the rear driver side extension inner surface along the rear driver side extension upper end;
a rear driver side mud flap upper mounting bracket (500) comprising at least one rear driver side bracket vehicle connection hole (510) configured to connect the rear driver side mud flap upper mounting bracket to a vehicle third surface (53) by a sixth fastener (520), and at least one rear driver side extension connection hole (530) configured to connect the rear driver side mud flap upper mounting bracket to the rear driver side mud flap mounting extension by a seventh fastener (540) passing through the rear driver side mud flap mounting slot and into the rear driver side extension connection hole; and
a rear driver side central mounting bracket assembly (600) comprising:
a rear driver side mud flap attachment (610) comprising:
a plurality of rear driver side mud flap connection holes (611) with each rear driver side mud flap connection hole configured to connect the rear driver side mud flap attachment to the rear driver side mud flap by passing an eighth fastener (612) through a rear driver side mud flap connection hole of the plurality of rear driver side mud flap connection holes and into a rear driver side mud flap central mounting hole of the plurality of rear driver side mud flap central mounting holes; and
at least one rear driver side mud flap attachment slot (613); and
a rear driver side attachment mechanism (620) comprising at least one rear driver side connection hole (621) configured to connect he rear driver side attachment mechanism to a vehicle fourth surface (54) by a ninth fastener (622), and at least one rear driver side vehicle attachment connection hole (623) configured to connect the rear driver side attachment mechanism to the rear driver side mud flap attachment by a tenth fastener (624) passing through the rear driver side mud flap attachment slot and into the rear driver side vehicle attachment connection hole.

20. The mud flap kit of claim 19, further comprising:
a front passenger side mud flap (700) comprising:
a front passenger side mud flap interior edge (710), a front passenger side mud flap exterior edge (720) opposite the front passenger side mud flap interior edge, a front passenger side mud flap lower end (730), and a front passenger side mud flap upper end (740) opposite the front passenger side mud flap lower end, said front passenger side mud flap interior edge, front passenger side mud flap exterior edge, front passenger side mud flap lower end, and front passenger side mud flap upper end forming a front passenger side mud flap plane defining a front passenger side mud flap outer surface (750) and a front passenger side mud flap inner surface (760) opposite the front passenger side mud flap outer surface, and a front passenger side mud flap recess (725) extending from the front passenger side mud flap interior edge towards the front passenger side mud flap exterior edge between the front passenger side mud flap lower end and the front passenger side mud flap upper end;
a front passenger side mud flap mounting extension (770) extending from a portion of the front passenger side mud flap upper end said front passenger side mud flap mounting extension having a front passenger side extension interior edge (771), a front passenger side extension exterior edge (772) opposite the front passenger side extension interior edge, a front passenger side extension lower end (773) connected to the front passenger side mud flap upper end, and a front passenger side extension upper end (774) opposite the front passenger side extension lower end, said front passenger side extension interior edge, front passenger side extension exterior edge, front passenger side extension lower end, and front passenger side extension upper end forming a front passenger side extension plane defining a front passenger side extension outer surface (775) and a front passenger side extension inner surface (776) opposite the front passenger side extension outer surface; and
a plurality of front passenger side mud flap mounting slots (780) comprising at least:
a front passenger side mud flap upper mounting slot (781) passing from the front passenger side extension outer surface through the front passenger side extension inner surface;
a front passenger side mud flap lower mounting slot (782) passing from the front passenger side mud flap outer surface through the front passenger side mud flap inner surface;
a front passenger side mud flap central mounting slot (783) passing from the front passenger side extension outer surface through the front passenger side extension inner surface between the front passenger side mud flap upper mounting slot and the front passenger side mud flap lower mounting slot;
a front passenger side mounting bracket (800) comprising at least one front passenger side bracket vehicle connection hole (810) configured to connect the front passenger side mounting bracket to a vehicle fifth surface (55) by an eleventh fastener (820), and at least one front passenger side extension connection hole (830) configured to connect the front passenger side mounting bracket to the front passenger side mud flap mounting extension by a twelfth fastener (840) passing through the front passenger side mud flap upper mounting slot or the front passenger side mud flap central mounting slot and into the front passenger side extension connection hole;
a front drive side mud flap (900) comprising:
a front drive side mud flap interior edge (910), a front drive side mud flap exterior edge (920) opposite the front drive side mud flap interior edge, a front drive side mud flap lower end (930), and a front drive side mud flap upper end (940) opposite the front drive side mud flap lower end, said front drive side mud flap interior edge, front drive side mud flap exterior edge, front drive side mud flap lower end, and front drive side mud flap upper end forming a front drive side mud flap plane defining a front drive side mud flap outer surface (950) and a front drive side mud flap inner surface (960) opposite the front drive side mud flap outer surface, and a front drive side mud flap recess (925) extending from the front drive side mud flap interior edge towards the front drive side mud flap exterior edge between the front drive side mud flap lower end and the front drive side mud flap upper end;
a front drive side mud flap mounting extension (970) extending from a portion of the front drive side mud flap upper end said front drive side mud flap mounting extension having a front drive side extension interior edge (971), a front drive side extension exterior edge (972) opposite the front drive side extension interior edge, a front drive side extension lower end (973) and a front drive side extension upper end (974) opposite the front drive side extension lower end, said front drive side extension interior edge, front drive side extension exterior edge, front drive side extension upper end, and front drive side extension lower end forming a front drive side extension plane defining a front drive side extension outer surface (975) and a front drive side extension inner surface (976) opposite the front drive side extension outer surface; and
a plurality of front drive side mud flap mounting slots (980) comprising at least:
a front drive side mud flap upper mounting slot (981) passing from the front drive side extension outer surface through the front drive side extension inner surface;
a front drive side mud flap lower mounting slot (982) passing from the front drive side mud flap outer surface through the front drive side mud flap inner surface; and
a front drive side mud flap central mounting slot (983) passing from the front drive side extension outer surface through the front drive side extension inner surface between the front drive side mud flap upper mounting slot and the front drive side mud flap lower mounting slot; and
a front drive side mounting bracket (1000) comprising at least one front drive side bracket vehicle connection hole (1010) configured to connect the front drive side mounting bracket to a vehicle sixth surface (56) by a thirteenth fastener (1020), and at least one front drive side extension connection hole (1030) configured to connect the front drive side mounting bracket to the front drive side mud flap mounting extension by a fourteenth fastener (1040) passing through the front drive side mud flap upper mounting slot or the front drive side mud flap central mounting slot and into the front drive side extension connection hole.
